(19) United States
(12) Patent Application Publication
(10) Pub. No.: US 2019/0314908 A1
(43) Pub. Date: Oct. 17, 2019

(54) TABLETOP CUTTING DEVICE

(71) Applicant: MAKITA CORPORATION, Anjo-shi, Aichi (JP)

(72) Inventors: Syuji AOYAMA, Anjo-shi (JP); Yukinori SUZUKI, Anjo-shi (JP); Goh YAMAMURA, Anjo-shi (JP)

(73) Assignee: MAKITA CORPORATION, Anjo-shi, Aichi (JP)

(21) Appl. No.: 16/340,557

(22) PCT Filed: Nov. 8, 2017
(86) PCT No.: PCT/JP2017/040187

§ 371 Date: Apr. 9, 2019

(30) Foreign Application Priority Data
Nov. 11, 2016 (JP) 2016-220815

(51) Int. Cl. B23D 45/04; B23D 45/14; B27B 5/20; B27B 5/36

(52) U.S. Cl. CPC B23D 45/04; B27B 5/36; B27B 5/20; B23D 45/14

(57) ABSTRACT

An operation knob is attached to one end of a transmission rod. The transmission rod is located in a slide bar supporting a cutting device main body so as to be slidable in a front-to-rear direction. A pulley of a belt transmission mechanism is joined to the other end of the transmission rod, and a click mechanism is arranged around a portion of the pulley. The click mechanism provides a tactile sensation (e.g. click feeling or feeling of moderation) and improves operability of the operation knob.

### TECHNICAL FIELD

This application relates to a tabletop cutting device, which is referred to as, for example, a sliding circular saw or a tabletop circular saw, and which is used for cutting a workpiece, such as mainly a wooden material, to be cut.

### BACKGROUND ART

Japanese Laid-Open Patent Publication No. 2015-150633 discloses a tabletop cutting device. The tabletop cutting device includes a table on which a workpiece to be cut is placed, as well as a cutting device main body that is supported on a rear part of the table so as to be movable in an up-and-down direction. The cutting device main body includes a circular cutting blade (cutting edge) that can be rotated by using an electric motor as a driving source. Cutting work can be performed by moving the cutting main body in a downward direction while the cutting blade is rotating.

An oblique cutting of the workpiece can be performed by tilting the cutting main body, for example, in a leftward direction and causing the cutting blade to cut into the workpiece. An inclination position of the cutting device main body is fixed by, for example, a rotation operation of an operation knob used for fixing the inclination position. The operation knob is arranged at a place where a user can operate it in an easy manner. A screw shaft portion used for fixing the inclination position is provided in a vicinity of a rear part of the table. The operation knob is arranged in a vicinity of an upper front part of the table closer to the user. A belt transmission mechanism is interposed between the screw shaft portion and the operation knob. By using this mechanism, the inclination position of the cutting device main body can be remotely operated and fixed. The user can fix the inclination position by rotating the operation knob in a more comfortable position in comparison with a case where the user has to stretch his/her hand to the vicinity of the rear part of the table for the fastening operation. In this way, operability of the cutting device main body in the inclination fixing mechanism can be improved.

### SUMMARY OF INVENTION

### Problems to be Solved by the Invention

However, there is a need to further improve the operability in the above-described remotely-operation-type inclination fixing mechanism in the prior art.

### Means for Solving the Problems

According to one feature of the present invention, a tabletop cutting device is provided in which a cutting angle of a workpiece to be cut can be changed by allowing a cutting device main body to be inclined in a left-to-right direction with respect to a table on which the workpiece is placed. The tabletop cutting device includes an operation knob that is rotated for fixing an inclination position of the cutting device main body. Furthermore, the tabletop cutting device includes a click mechanism that produces a click feeling, when the operation knob is rotated.

Because of this configuration, a user can recognize a fixing state of the inclination position of the cutting device main body in a sensible manner by obtaining a click feeling (feeling of moderation) with his/her hand while rotating the operation knob. In this respect, operability of the operation knob and the inclination fixing mechanism can be improved. Furthermore, over-fastening of the operation knob can be prevented.

According to another feature, the rotational operation of the operation knob is transmitted to a left/right inclination shaft via a transmission rod that is different from the left/right inclination shaft. The left/right inclination shaft is configured to support the cutting device main body so as to incline the cutting device main body in a left-to-right direction. The click mechanism is arranged around the transmission rod. Because of this configuration, the click feeling caused by the click mechanism is directly transmitted to the operation knob via the transmission rod, which improves operability of the device.

According to another feature, the tabletop cutting device includes a slide bar that supports the cutting device main body so as to be slidable in a front-to-rear direction. The operation knob is rotatably supported at a front end of the slide bar. The transmission rod is inserted in the inner circumference of the slide bar. The rotational operation of the operation knob is transmitted to the left/right inclination shaft via a belt transmission mechanism that is interposed between the transmission rod and the left/right inclination shaft. An engagement portion used for the click mechanism is provided in a pulley on a side of the transmission rod.

Therefore, the operation knob and the transmission rod are supported by utilizing the slide bar that supports the cutting device main body so as to be slidable in the front-to-rear direction. Because of this configuration, the number of components of the cutting device can be reduced. Furthermore, the engagement portion used for the click mechanism is provided in the pulley on the side of the transmission rod. Because of this, the number of components of the cutting device can be reduced, in comparison with a case where the engagement portion is provided by utilizing dedicated components that are separately made.

According to another feature, a tabletop cutting device is provided in which a cutting angle of a workpiece to be cut can be changed by allowing a cutting device main body to be inclined in a left-to-right direction with respect to a table on which the workpiece is placed. The cutting device main body is supported via a main body supporting portion, so as to be inclined with respect to the table in the left-to-right direction. A left/right inclination position of the cutting device main body with respect to the table is configured to be fixed by fastening a left/right inclination shaft provided in the main body supporting portion. The cutting device main body is supported so as to be slidable via a slide bar provided in the main body supporting portion. An operation knob is provided at one end of a transmission rod that is inserted in the slide bar. A belt transmission mechanism is interposed between the other end of the transmission rod and the left/right inclination shaft. A rotational operation of the operation knob is configured to be transmitted to the left/right inclination shaft via the belt transmission mechanism. The tabletop cutting device further comprises a belt pressing portion that presses a toothed belt of the belt transmission mechanism in an engagement direction of a pulley.

Because of this configuration, the belt pressing portion prevents the belt from lifting from the pulley, and thus a disengagement of the toothed belt from the pulley is prevented. Because of this, if an abrupt fastening torque is applied to the pulley, an operation of the operation knob can be transmitted to the left/right inclination shaft via the toothed belt in a sufficient manner, and thus the inclination position of the cutting device main body can be firmly fixed.

According to another feature, the belt pressing portion is arranged to the front of the fastening direction of the left/right inclination shaft with respect to the pulley. When a toothed belt is spaced apart from a pulley, rotation of the operation knob in the fastening direction tends to cause the toothed belt to lift in the front of the fastening direction. However, the belt pressing portion restricts the lift of the toothed belt.

According to another feature, the belt pressing portion is arranged in the vicinity of the pulley. Because of this configuration, the lift of the belt from the pulley is efficiently restricted. Thus, disengagement of the toothed belt from the pulley is prevented in a sufficient manner.

According to another feature, a plurality belt pressing portions are arranged at a different places. Because of this configuration, the lift of the toothed belt from the pulley is restricted in a sufficient manner. Thus, the operation power of the operation knob is transmitted to the left/right inclination shaft in a sufficient manner.

### BRIEF DESCRIPTION OF THE DRAWINGS

FIG. 1 is an overall perspective view of a tabletop cutting device according to a present embodiment, which is obliquely viewed from a forward left direction.

FIG. 2 is an overall side view of the tabletop cutting device according to the present embodiment, which is viewed from a left side (transverse side) thereof.

FIG. 3 is an overall top view of the tabletop cutting device according to the present embodiment.

FIG. 4 is an overall view of the tabletop cutting device according to the present embodiment, which is viewed from a front side (user side).

FIG. 5 is an overall side view of the tabletop cutting device according to the present embodiment, which is viewed from a right side (back side) thereof.

FIG. 6 is an overall view of the tabletop cutting device according to the present embodiment, which is viewed from a rear side thereof.

FIG. 7 is a top view of a table and a base.

FIG. 8 is a bottom view of the table and the base.

FIG. 9 is a bottom view of a rotation lock operation portion of the table, which is viewed from below the bottom thereof.

FIG. 10 is a cross-sectional view taken along line (X)-(X) of FIG. 9, showing a longitudinal cross-sectional view of mainly a front side of the table. This figure shows mainly a first rotation lock mechanism.

FIG. 11 is a cross-sectional view taken along line (XI)-(XI) of FIG. 9, showing a longitudinal cross-sectional view of mainly the front side of the table. This figure shows mainly a second rotation lock mechanism.

FIG. 12 is a cross-sectional view taken along line (XII)-(XII) of FIG. 10, showing a longitudinal sectional view of the rotation lock operation portion.

FIG. 13 is a right side view of both a rear side of the table and a lower side of a main body supporting portion.

FIG. 14 is a cross-sectional view taken along line (XIV)-(XIV) of FIG. 13, showing a longitudinal sectional view of a right-angled positioning mechanism. This figure shows a longitudinal sectional view of an inclination-receiving portion.

FIG. 15 is a left side view of an inclination positioning mechanism. This figure shows that an inclination positioning rod is moved to a 45° positioning point.

FIG. 16 is a left side view of the inclination positioning mechanism. This figure shows that the inclination positioning rod is moved to a 48° positioning point.

FIG. 17 is a cross-sectional view taken along line (XVII)-(XVII) of FIG. 15, showing a longitudinal cross-sectional view of the inclination positioning mechanism. This figure shows a longitudinal sectional view of an inclination-supporting portion.

FIG. 18 is a perspective view of a single inclination positioning rod.

FIG. 19 is a longitudinal sectional view of an inclination fixing mechanism.

FIG. 20 is a view of the inclination fixing mechanism, which is viewed from a rear side thereof.

FIG. 21 is a cross-sectional view taken along line (XXI)-(XXI) of FIG. 20, showing a longitudinal cross-sectional view of a second pulley and its surroundings.

FIG. 22 is a top view of a cutting device main body, showing that the cutting device main body is swung to a lower moving end.

FIG. 23 is a cross-sectional view taken along line (XXIII)-(XXIII) of FIG. 22, showing a longitudinal sectional view of the cutting device main body. In this figure, the cutting main body that is swung to the lower moving end is viewed from the front side.

FIG. 24 is a cross-sectional view taken along line (XXIV)-(XXIV) of FIG. 22, showing a longitudinal sectional view of the cutting device main body. In this figure, the cutting main body that is swung to the lower moving end is viewed from the front side.

FIG. 25 is a cross-sectional view of an electric motor.

FIG. 26 is a cross-sectional view taken along line (XXVI)-(XXVI) of FIG. 5, showing a cross-sectional view of a dust collection hose connection portion that is connected to a main body side connection port.

FIG. 27 is a cross-sectional view taken along line (XXVII)-(XXVII) of FIG. 5, showing a cross-sectional view of the dust collection hose connection portion that is connected to a supporting side connection port of a relay duct.

FIG. 28 is a cross-sectional view taken along line (XXVIII)-(XXVIII) of FIG. 5, showing a cross-sectional view of the relay duct.

FIG. 29 is an overall top view of the tabletop cutting device. This figure shows a state in which auxiliary fences are received by holder fittings.

FIG. 30 is a perspective view of the auxiliary fence received by the holder fitting, which is obliquely viewed from below thereof.

FIG. 31 is a perspective view of the auxiliary fence, which is obliquely viewed from below thereof.

FIG. 32 is an overall perspective view of the tabletop cutting device, which is obliquely viewed from a forward left direction. This figure shows a state in which a vertical vise is attached to the cutting device.

FIG. 33 is a modification of the embodiment shown in FIGS. 29 to 32. This figure shows a state in which the auxiliary fences are retained flush with a seat portion of the base.

FIG. 34 is an overall perspective view of the tabletop cutting device, showing that the vertical vise is supported by the auxiliary fence that is retained flush with the seat portion of the base.

FIG. 35 is an overall perspective view of the tabletop cutting device, showing a state in which the cutting device main body is moved to the lower moving end position.

FIG. 36 is a cross-sectional view of a swing lock mechanism, showing a locked state.

FIG. 37 is a cross-sectional view of the swing lock mechanism, showing an unlocked state.

FIG. 38 is an overall perspective view of the tabletop cutting device. This figure shows that the cutting device main body which is swung to the lower moving end position is slid to a slide retreat end position.

FIG. 39 is a longitudinal cross-sectional view of a second pulley and its surroundings according to a second embodiment.

FIG. 40 is a longitudinal cross-sectional view of a second pulley and its surroundings according to a third embodiment.

FIG. 41 is a longitudinal cross-sectional view of a second pulley and its surroundings according to a fourth embodiment.

FIG. 42 is a longitudinal cross-sectional view of a second pulley and its surroundings according to a fifth embodiment.

FIG. 43 is a rear view of the second pulley and its surroundings of FIG. 42, showing a state in which an arm cover is removed.

FIG. 44 is a longitudinal cross-sectional view of a second pulley and its surroundings according to a sixth embodiment.

FIG. 45 is a rear view of the second pulley and its surroundings of FIG. 44, showing a state in which an arm cover is removed.

FIG. 46 is a front view of the second pulley and its surroundings according to a seventh embodiment, showing a state in which an arm cover is removed.

FIG. 47 is a front view of the second pulley and its surroundings of FIG. 46, showing that the second pulley of FIG. 46 is rotated.

FIG. 48 is a longitudinal cross-sectional view of a second pulley and its surroundings according to an eighth embodiment.

FIG. 49 is a rear view of the second pulley and its surroundings of FIG. 48, showing a state in which an arm cover is removed.

FIG. 50 is a longitudinal cross-sectional view of a second pulley and its surroundings according to a ninth embodiment.

FIG. 51 is a rear view of the second pulley and its surroundings of FIG. 50, showing a state in which an arm cover is removed.

FIG. 52 is a longitudinal cross-sectional view of a second pulley and its surroundings according to a tenth embodiment.

FIG. 53 is a rear view of the second pulley and its surroundings of FIG. 52, showing a state in which an arm cover is removed.

### EMBODIMENTS FOR CARRYING OUT THE INVENTION

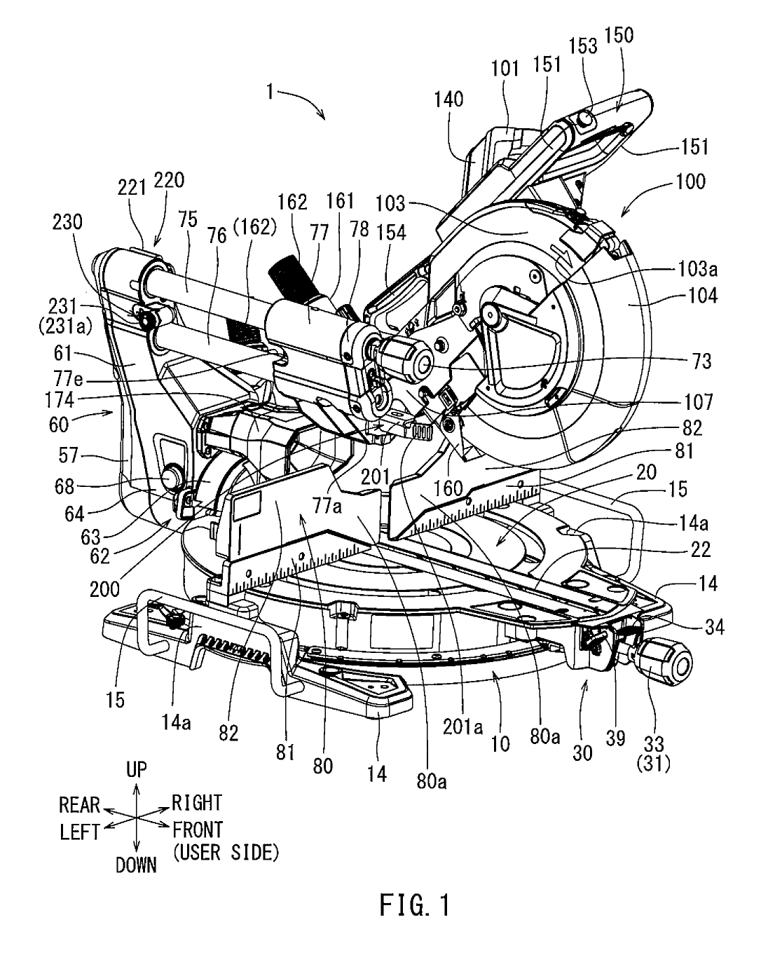

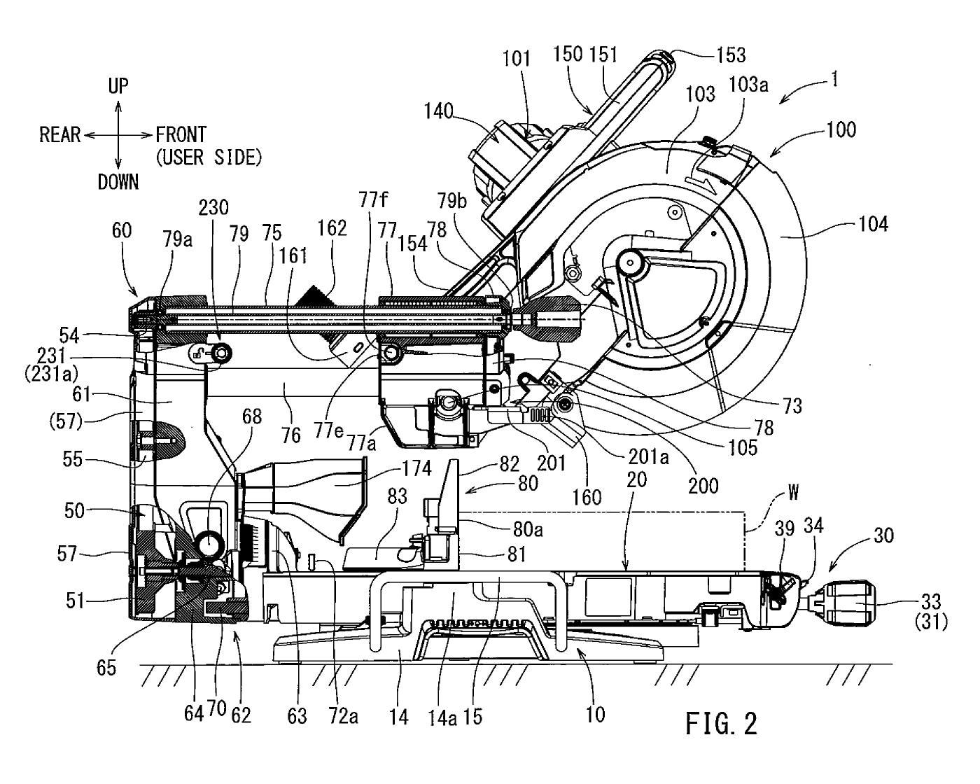

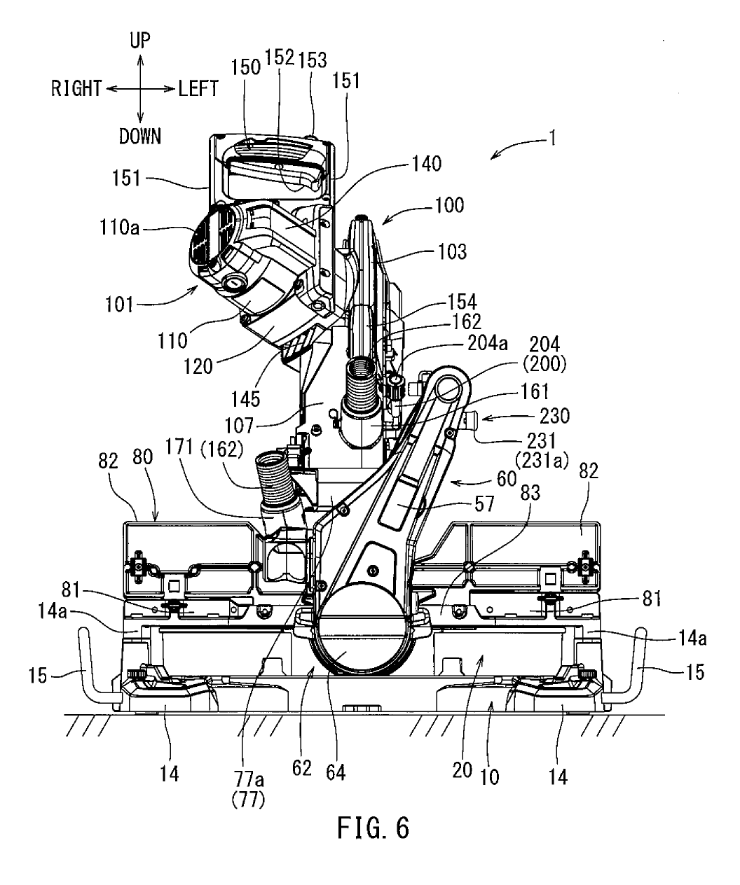

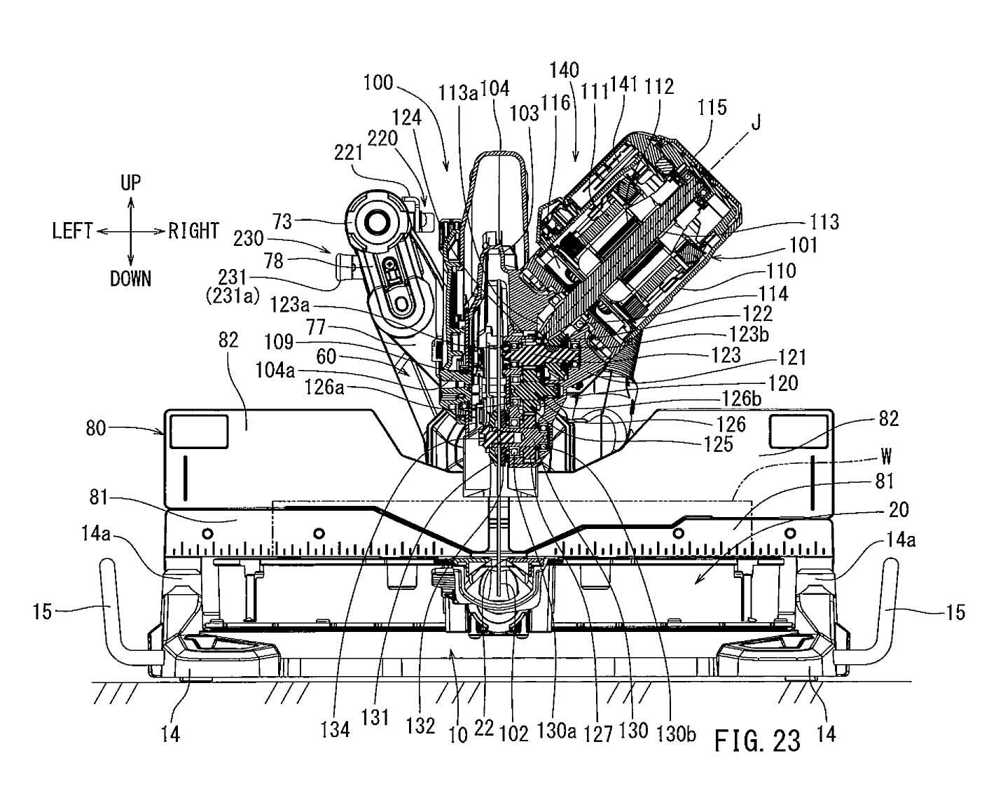

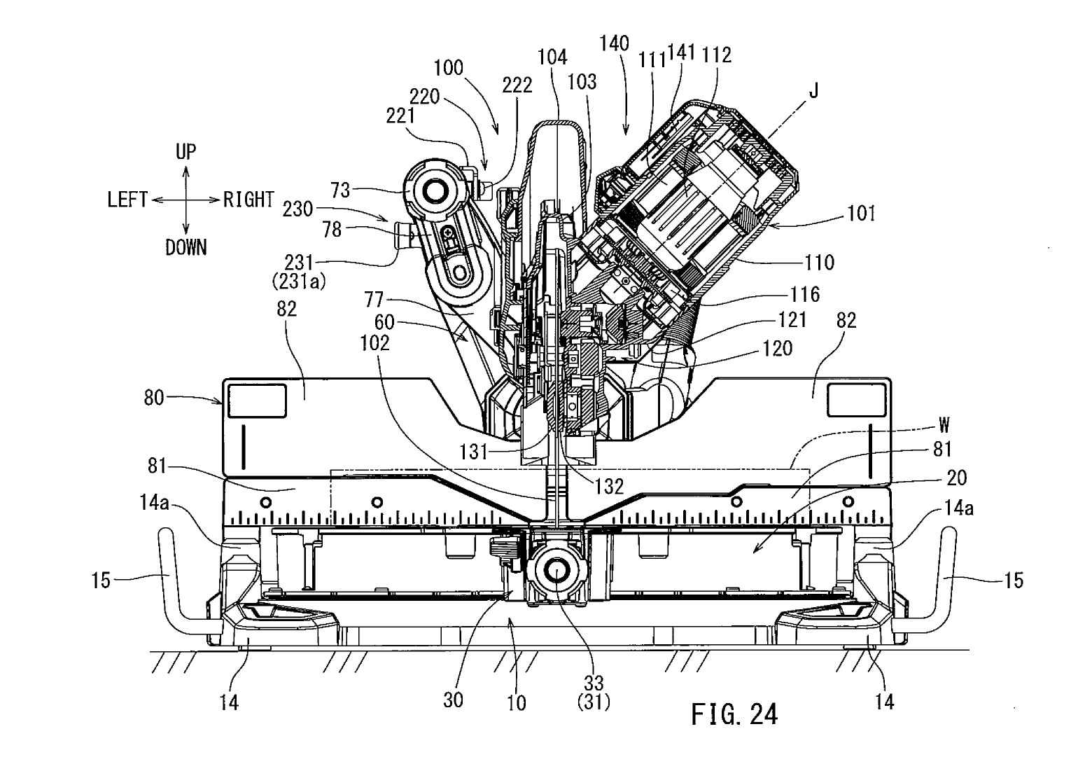

Embodiments according to the present invention will be described with reference to FIGS. 1 to 38. FIGS. 1 to 6 show an overall view of a desktop cutting device 1 of the present embodiment. In FIGS. 1 and 2, a user is situated on a right side of the tabletop cutting device 1 in order to perform cutting work. In the following embodiments, the front, rear, leftward, rightward, upward, and downward directions of members and configurations are based on the user's position. Furthermore, a near side to the user, depicting the user's point of view, is referred to as the front side (user side).

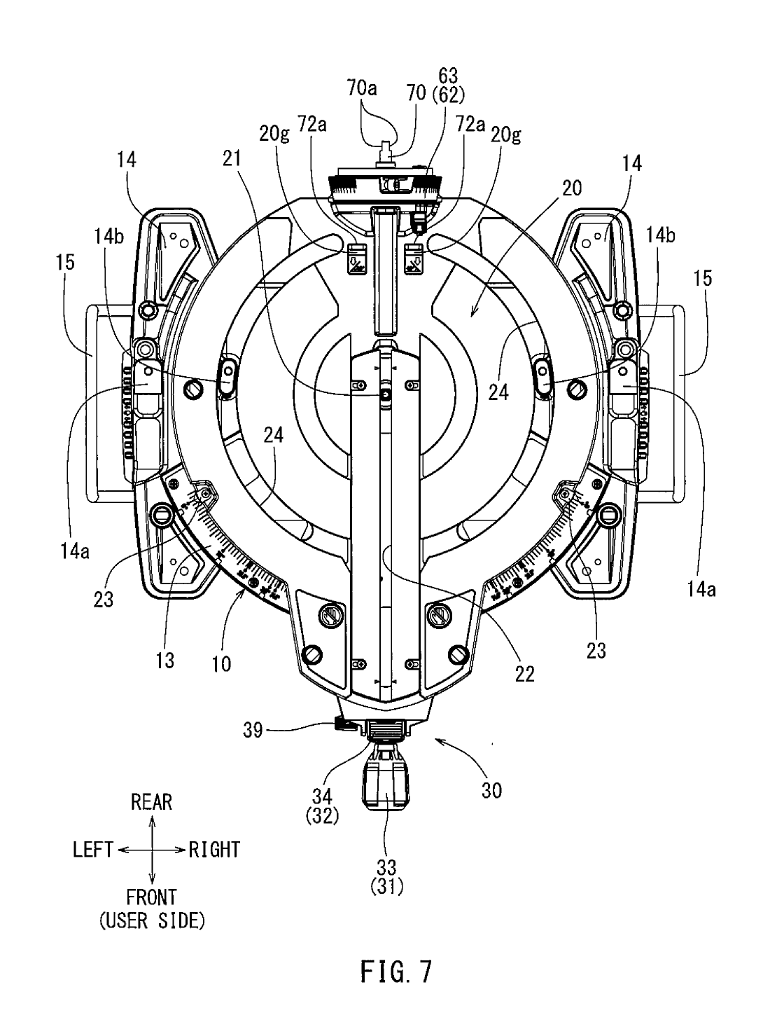

The desktop cutting device 1 is often referred to as a so-called sliding compound miter saw, which includes a table 20 on which a workpiece W to be cut is placed, a base 10 that supports the table 20 so as to be horizontally rotatable, and a cutting device main body 100 having a circular cutting blade 102. As though not shown in FIGS. 1 to 6, the table 20 is horizontally rotatable via a rotation support shaft 21 that is located approximately at the radial center on the upper surface of the base 10. The rotation support shaft 21 can be seen in FIG. 7, where it is shown below a cutting edge plate 22. The cutting edge plate 22 is a band plate that includes a groove slot hole through which the circular cutting blade 102 is passed. The cutting edge plate 22 is attached so as to be flush with the upper surface of the table 20. The groove slot hole of the cutting edge plate 22 is provided extending a full diameter length in the radial direction passing through the rotation support shaft 21 (at the radial center of the table 20).

There are provided on the upper side of the table 20, the cutting edge plate 22 and a positioning fence 80 for positioning the workpiece W on the surface direction of the table 20. A rotation lock operation portion 30 for locking a rotation position of the table 20 is provided on the front side of the table 20. On the rear side of the table 20, the cutting device main body 100 is supported via a main body supporting portion 60. The main body supporting portion 60 is provided with a supporting mechanism in which the cutting device main body 100 can be supported so as to be swung in an up-to-down direction above the table 20, tilted in an left-to-right direction, and slid in a front-to-rear direction. By swinging the cutting device main body 100 in the downward direction, the workpiece W that is placed on the table 20 can be cut by the cutting blade 102. Furthermore, by sliding the cutting device main body 100 in the rearward direction while the cutting blade 102 cuts the workpiece W, cutting work of the workpiece W can be processed in the rearward direction to completely cut the workpiece W with a wide width.

[Rotation Lock Mechanism of the Table 20]

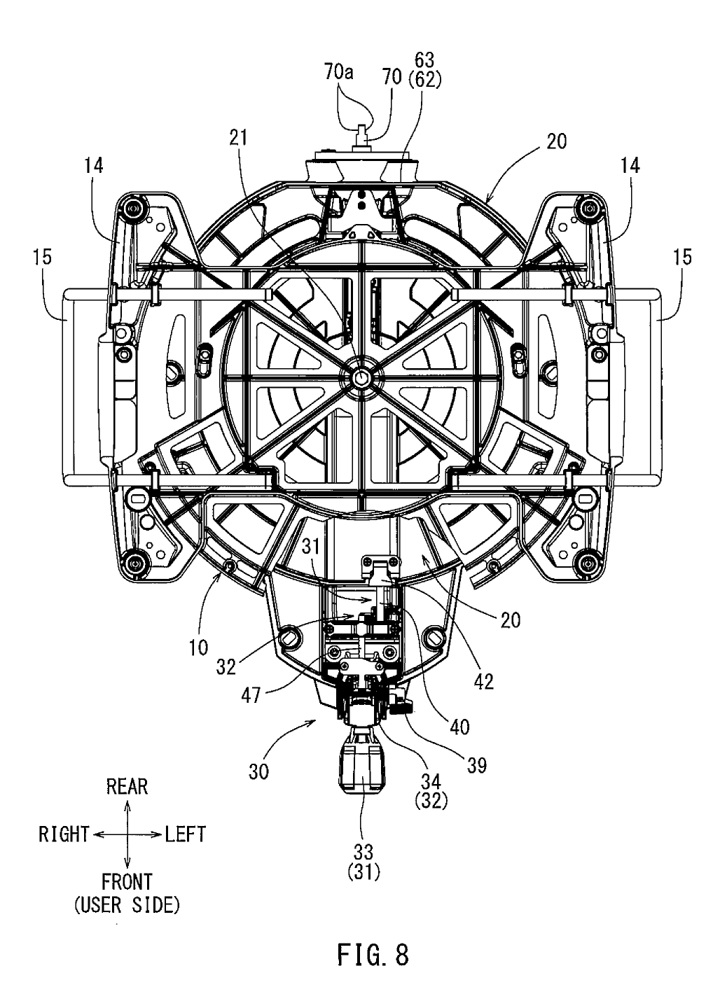

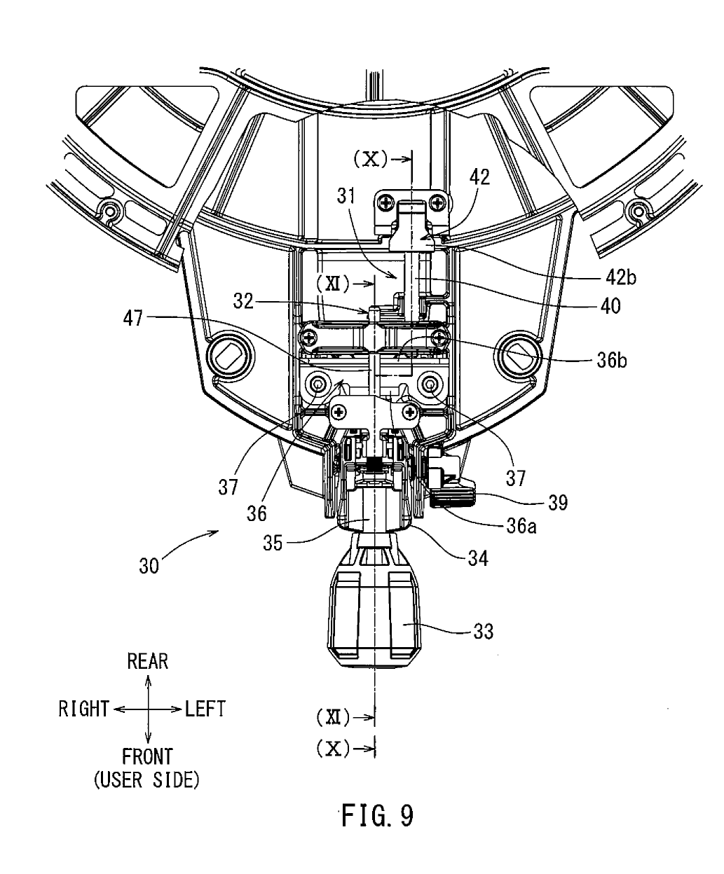

A rotation position of the table 20 with respect to the base 10 can be locked at a definite (and/or desired) angle position by selecting and using either one of a first rotation lock mechanism 31 and a second rotation lock mechanism 32. As shown in FIGS. 7 and 8, operation portions of the first rotation lock mechanism 31 and the second rotation lock mechanism 32 is positioned in a rotation lock operation portion 30 that is provided on the front side of the table 20. The details of the first rotation lock mechanism 31 and the second rotation lock mechanism 32 are shown in, for example, FIG. 9. The first rotation lock mechanism 31 includes a function of locking the table 20 at an arbitrary angle position. In the first rotation lock mechanism 31, the table 20 can be locked and unlocked by rotating an operation member 33 that is arranged as part of the rotation lock operation portion 30. The second rotation lock mechanism 32 can be locked and unlocked by the swinging of operation member 34 in the up-to-down direction, which is arranged as part of the rotation lock operation member 30.

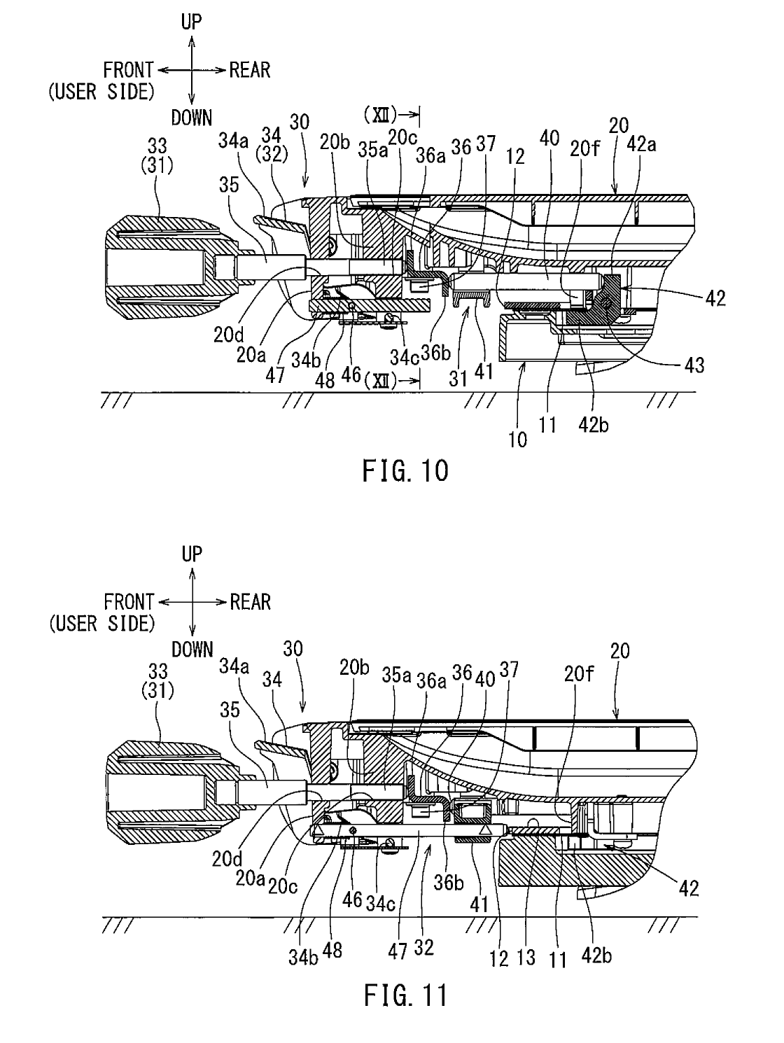

As shown in FIGS. 10 and 11, the operation member 33 of the first rotation lock mechanism 31 is attached to an end portion of the screw shaft 35. The screw shaft 35 is supported straddling a supporting wall 20a as well as a supporting wall 20b, both of which are provided at the front side of the table 20. The screw shaft 35 is passed through both the supporting wall 20a and the supporting wall 20b, and the screw shaft 35 is supported so as to be rotatable about its axis. Furthermore, the screw shaft 35 passes through the supporting-hole 20d provided in the front-side supporting wall 20a in such a way so as to be un-displaceable in the radial direction, but displaceable in the axial direction. A screw portion 35a may be provided on the rear part of the screw shaft 35. The screw portion 35a is fastened to a screw hole 20c provided in the rear-side supporting wall 20b. Because of this configuration, when the operation member 33 rotates, the screw shaft 35 advances or retreats along its axis (in the front-to-rear direction) by a screw engagement of the screw portion 35a with regard to the screw hole 20c. When the operation member 33 is rotated toward a lock side, the screw portion 35a is fastened with respect to the screw hole 20c, and the screw shaft 35 moves toward the rear side. In contrast, when the operation member 33 is rotated to an unlock side, the screw portion 35a is released with respect to the screw hole 20c, and the screw shaft 35 moves toward the front side.

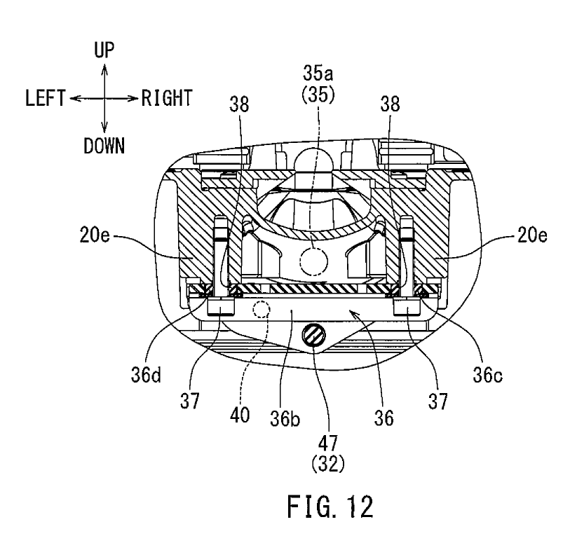

A transmission bracket 36 is supported on the rear side of the screw shaft 35. The transmission bracket 36 is a metal-made interposition member that is a band-like steel plate, which extends in the left-to-right direction, and bent in a crank shape in a cross section as shown in FIGS. 10 and 11. Furthermore, the transmission bracket 36 includes an upper contact portion 36a and a lower contact portion 36b. As shown in FIG. 12, the transmission bracket 36 straddles a left seat portion 20e as well as a right seat portion 20e, both of which are provided on a lower surface of the table 20, where the transmission bracket 36 is movably supported by both the seat portions 20e. The transmission bracket 36 is attached to the seat portions 20e by two fixing screws 37. The transmission bracket 36 includes an insertion hole 36c on the right side and an insertion hole 36d on the left side. Furthermore, the right-side insertion hole 36c is formed as a circular shape and the left-side insertion hole 36d is formed as a groove shape that extends in the front-to-rear direction and curves around the insertion hole 36c. An annular sleeve ring member 38 that is made from steel is attached to each of the right-side insertion hole 36c and the left-side insertion groove hole 36d. The fixing screw 37 is inserted into an inner circumference of each of the two sleeve ring members 38. The transmission bracket 36 is horizontally supported so as to be rotatable around the right-side sleeve member 38. A transmission rod 40 is pushed in the rearward direction by the rotational movement of the transmission bracket 36.

A rear end of the screw shaft 35 is brought into contact with a front surface of the upper contact portion 36a. Because of this configuration, when the operation member 33 rotates in the lock direction as described above, the screw shaft 35 moves toward the rear side and thus the transmission bracket 36 is pushed in the rearward direction. The transmission bracket 36 rotates around the sleeve member 38 and moves in the rearward direction by the pushing force of the screw shaft 35.

A rear surface of the lower contact portion 36b of the transmission bracket 36 is then brought into contact with a front end of the transmission rod 40. The transmission rod 40 is supported so as to be displaceable along its longitudinal axial direction (in the front-to-rear direction) via a rod-receiving portion 41 that is provided on the lower surface of the table 20. Furthermore, as shown in FIG. 9, the transmission rod 40 is arranged in parallel with the screw shaft 35 of the operation member 33 and offset on the left side with respect to the screw shaft 35. By rotating the transmission bracket 36 in the rearward direction, the transmission rod 40 moves in the rearward direction.

As shown in FIG. 10, a lock member 42 provided on the lower surface of the table 20 is supported on the rear side of the transmission rod 40. The lock member 42 is supported so as to be rotatable in the up-to-down direction via a support shaft 43. The lock member 42 includes an input portion 42a that extends in the upward direction from the support shaft 43 and an output portion 42b that extends in the forward direction from the support shaft 43, which forms in an L shape. A rear end of the transmission rod 40 is brought into contact with a front surface of the input portion 42a. Because of this configuration, when the transmission rod 40 moves in the rearward direction, the input portion 42a is pushed rearward. As a result, the lock member 42 rotates to the lock side about the support shaft 43 (that is, the lock member 42 rotates in a direction in which the input portion 42a moves in the rearward, which is a clockwise direction in FIG. 10). In this way, in the present embodiment, the transmission bracket 36 and the transmission rod 40 collectively function as a transmission member for transmitting a spring force produced by the rotation of the operation member 33 to the lock member 42.

When the input portion 42a is pushed in the rearward direction and the lock member 42 rotates to the lock side, the output portion 42b moves in the upward and rearward direction. A locked portion provided in the base 10 is positioned above the output portion 42b. In the present embodiment, the locked portion comprises a lock plate 11 that is fixed to the base 10 side. A holding (pinching) rib 20f provided on the lower surface of the table 20 is positioned above the lock plate 11. When the lock member 42 rotates to the lock side, the output portion 42b moves in the upward direction and the lock plate 11 is held (pinched) between the output portion 42b and the holding rib 20f.

The rearward axial movement of the screw shaft 35 made by the rotation of the operation member 33 produces the screw force. The screw force is further transmitted to the lock member 42 via the transmission bracket 36 and the transmission rod 40. By the rearward axial movement of the screw shaft 35, the output portion 42b of the lock member 42 moves in the upward direction, which holds the lock plate 11, and thus a rotation position of the table 20 with respect to the base 10 is locked. Because of this configuration in which the table 20 is locked by holding the lock plate 11 between the output portion 42b and holding rib 20f, the table 20 is locked at an arbitrary angle position within a predetermined angle range.

According to the above-described first rotation lock mechanism 31, the screw force is transmitted to the lock member 42 via the transmission bracket 36 and the transmission rod 40 serving as the transmission member. In this configuration, the screw shaft 35 pushes the transmission bracket 36 at a position relatively near the user. In contrast, according to the prior art disclosed in, for example, Japanese Laid-Open Patent Publication No. H09-131701, a long screw shaft is configured to push a lock member. Because of this configuration, a displacement amount of a tip end of the screw shaft with respect to the lock member (offset of the pushed position) may be large, and accordingly a transmission loss may be large, which causes a fixing force of the lock member to be insufficient. However, in the aforementioned first rotation lock mechanism 31, the screw shaft 35 that is short in length is configured to push the transmission member. Because of this configuration, a transmission loss of the screw force can be reduced compared to the prior art, and a large fixing force of the lock member 42 can consequently be produced so as to be sufficient in efficiently locking the position of the table 20.

As described, according to the first rotation lock mechanism 31, a rotational position of the table 20 is configure to be locked by vertically holding the lock plate 11 of the base 10. Because of this configuration, displacement of the table 20 can be prevented when the table 20 is locked. On the contrary, in prior art such as, for example, Japanese Laid-Open Patent Publication No. H05-318402, Japanese Laid-Open Patent Publication No. H09-131701, Japanese Laid-Open Patent Publication No. 2002-200602, and Japanese Laid-Open Patent Publication No. 2010-58229, a rotational position of the table is locked by pressing the lock member to the (round) base (only in one direction). Because of this unstable configuration, a reaction caused by the push movement of the lock member may slightly raise (lift) the table, which can cause a problem of impairing cutting accuracy. In contrast, in the aforementioned first rotation lock mechanism 31, the table 20 is configured to be locked by holding the lock plate 11 of the base 10 between the output portion 42b of the lock member 42 and the holding rib 20f of the table 20 from the up-to-down directions. Because of this stable configuration, a reaction caused by the push operation is canceled, and thus a positional offset, which can be caused by, for example, even a slight movement of the table 20 with regard to the base 10 in the upward direction (lift of the table 20) does not occur, improving cutting accuracy.

The tabletop cutting device 1 according to the present embodiment further includes the second lock mechanism 32 in addition to the first rotation lock mechanism 31. In the second rotation lock mechanism 32, the table 20 is locked at a plurality of predetermined angular positions within a predetermined angle range, which is referred to as a so-called positive lock. An operation member 34 of the second rotation lock mechanism 32 is arranged as part of the rotation lock operation portion 30. An operation knob 39 for retaining a pressed-down position (un-locked position) of the operation member 34 is provided on the left side of the rotation lock operation portion 30. As shown in FIGS. 10 and 11, the operation member 34 is supported in the rotation lock operation portion 30 so as to be swung along the up-to-down direction via a swing shaft 34c that is integrally formed on the rear side of the operation member 34. An operation portion 34a that the user presses down is provided on the front side of the operation member 34.

The operation member 34 is linked to a protrusion via an engagement shaft pin 46 in front of a swing shaft 34c. In the present embodiment, a lock pin 47 is used as the protrusion. The engagement shaft pin 46 is a pin with a diameter that is sufficiently thin compared to the lock pin 47, wherein the engagement shaft pin 46 is inserted into the lock pin 47 in the radial direction of the lock pin 47 passing width-wise through the longitudinal axis of the lock pin 47 so as to protrude in the left-to-right direction of the lock pin 47. The engagement shaft 46 is brought into contact with an inclined surface portion 34b of the operation member 34 from below thereof. The lock pin 47 is supported via the supporting wall 20a and the rod-receiving portion 41 so as to be displaceable along the front-to-rear direction. The lock pin 47 is arranged in parallel with the screw shaft 35 of the first rotation lock mechanism 31. Furthermore, in the planar view as shown in FIG. 9, the lock pin 47 is arranged coaxially with the screw shaft 35 in the front-to-rear direction. Because of this configuration, the lock pin 47 is arranged to be parallel to and offset with respect to the transmission rod 40 of the first rotation lock mechanism 31.

The operation member 34 causes the lock pin 47 to be biased in the rearward direction through insertion of a compression spring 48, interposed between the engagement shaft 46 and the supporting wall 20a. The operation member 34 is biased upward (in the lock direction) by the inclined surface portion 34b being pressed by the engagement shaft 46 from below thereof. By pushing the operation portion 34a down against the compression spring 48, the operation member 34 swings in the downward direction (in the unlocked direction). When the operation member 34 is moves downward in the up-to-down direction, the lock pin 47 correspondingly moves in the forward in the front-to-rear direction. Behind the lock pin 47, a plurality of lock recesses 12 are provided on the front side of the base 10 within a predetermined angle range. The plurality of the lock recesses 12 are provided at every predetermined angle interval.

In a state where the operation member 34 is disposed in the lock direction (in the upward direction) by the biasing force of the compression spring 48, this occurs firstly due to the lock pin 47 moving in the rearward direction. It is when the lock pin 47 moves in the rearward direction and enters into any one of the lock recesses 12, that a rotation position of the table 20 is locked. In this way, the lock position of the lock pin 47 is then retained by the biasing force of the compression spring 48. When the operation portion 34a of the operation member 34 is pressed down against the compression spring 48, the engagement shaft 46 is pushed by the lower surface of the inclined surface portion 34b, which moves downward, and the lock pin 47 consequently then moves in the forward direction. When the lock pin 47 moves in the forward direction, a rear portion of the lock pin 47 is extracted from the lock recess 12. By moving the lock pin 47 in the forward direction and extracting it from the lock recess 12, the table 20 is unlocked to be rotatable via the second rotation lock mechanism 32.

The pressed-down state of the operation member 34 (unlocked state) is facilitated by a user operating the operation knob 39 that is provided on the left side of the rotation lock operation portion 30. By putting the operation member 34 in the pressed-down position, the lock pin 47 is retained in an extracted state from the lock recess 12. In the aforementioned first rotation lock mechanism 31, the table 20 is positioned at any arbitrary angle position in a state where the lock pin 47 is extracted from the lock recess 12. When a rotation position of the table 20 is positioned by using the first rotation lock mechanism 31, the operation member 34 of the second rotation lock mechanism 32 is retained in an unlocked state by turning of the operation knob 39, which causes a positioning of the table 20 by the first rotation lock mechanism 32 to be performed rapidly and reliably. When positioning of the table 20 is not performed by the first rotation lock mechanism 31, the locked state of the operation member 34 is retained by turning the operation knob 39 upward, which retains a locked state of the pressed-down operation of the operation member 34 with spring compression. Because of this operation, the operation member 34 returns to a lock position (in the upward direction) by the biasing force of the compression spring 48. By returning the operation member 34 in the lock position (in the upward direction), the lock pin 47 retreats (moving in the rearward direction) and thus the rear end portion of the lock pin 47 is inserted to the lock recess 12, which causes the table 20 to be positioned rotationally in one of the predetermined angle positions.

As shown in FIG. 7, an angle scale 13 for indicating the horizontal rotational position of the table 20 is attached on the front side of the base 10. An indicator (pointer) is provided at a left-to-right symmetric position of the table 20. An angle position of the table 20 can be confirmed by reading the angle scale 13 at the region indicated by the indicator 23. FIG. 7 shows a state where the table 20 is locked at an angle position of 0°. In the present embodiment, the rotational position of the table 20 can be changed within an angle range of approximately 60° in the left-to-right direction. According to the first rotation lock mechanism 31, a rotation position of the table 20 can be locked at an arbitrary angle position within the angle range of approximately 60° in the left-to-right direction. According to the second rotation lock mechanism 32, the rotational position of the table 20 can be locked at equally spaced intervals of, for example, 10° within the angle range of approximately 60° in the left-to-right direction with excellent repeating accuracy. An angle position which cannot be locked by the second rotation lock mechanism 32, is locked by the first rotation lock mechanism 31.

[Inclination Positioning Mechanism 62 of the Cutting Device Main Body 100]

As shown in FIGS. 1 and 2, the cutting device main body 100 is supported at the rear of the table 20 via the main body supporting portion 60. The cutting device main body 100 is supported so as to be swung along the up-to-down direction with respect to the upper surface of the table 20, to be slid along the front-to-rear direction, and to be tilted along the left-to-right direction. The main body supporting portion 60 is provided with a main body supporting arm 61 that extends in the upward direction from the rear of the table 20. Furthermore, a right-angled positioning mechanism 90 and an inclination positioning mechanism (oblique positioning mechanism) 62 are provided between a lower portion of the main body supporting arm 61 and the rear portion of the table 20.

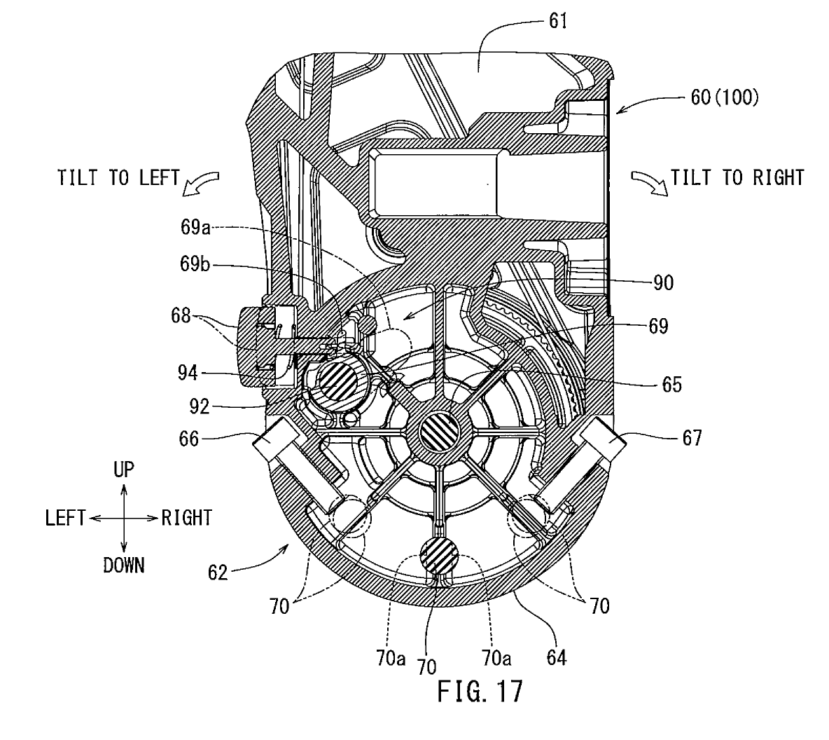

A tubular inclination-receiving portion 63 is formed integrally with the table 20 at the rear of the table 20. Furthermore, an inclination-supporting portion 64 is formed integrally with the main body supporting arm 61, which includes a tubular joining surface, on the lower front surface of the main body supporting arm 61. As shown in FIG. 17, the inclination-supporting portion 64 is joined to the inclination-receiving portion 63 so as to be rotatable via a single left/right inclination shaft 65. FIGS. 2, 19, and 20 show the left/right inclination shaft 65. The main body supporting arm 61 and the cutting device main body 100 are supported so as to be inclined in the left-to-right direction about the front-to-rear longitudinal axis of the left/right inclination shaft 65. The axis of the left/right inclination shaft 65 corresponds to the upper surface of the table with respect to the up-to-down direction.

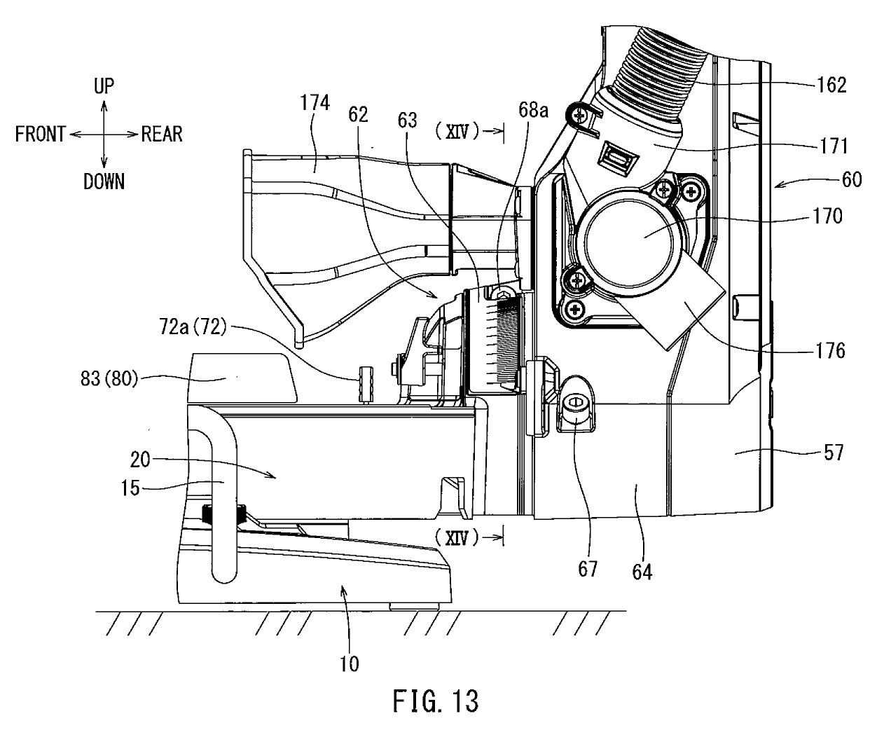

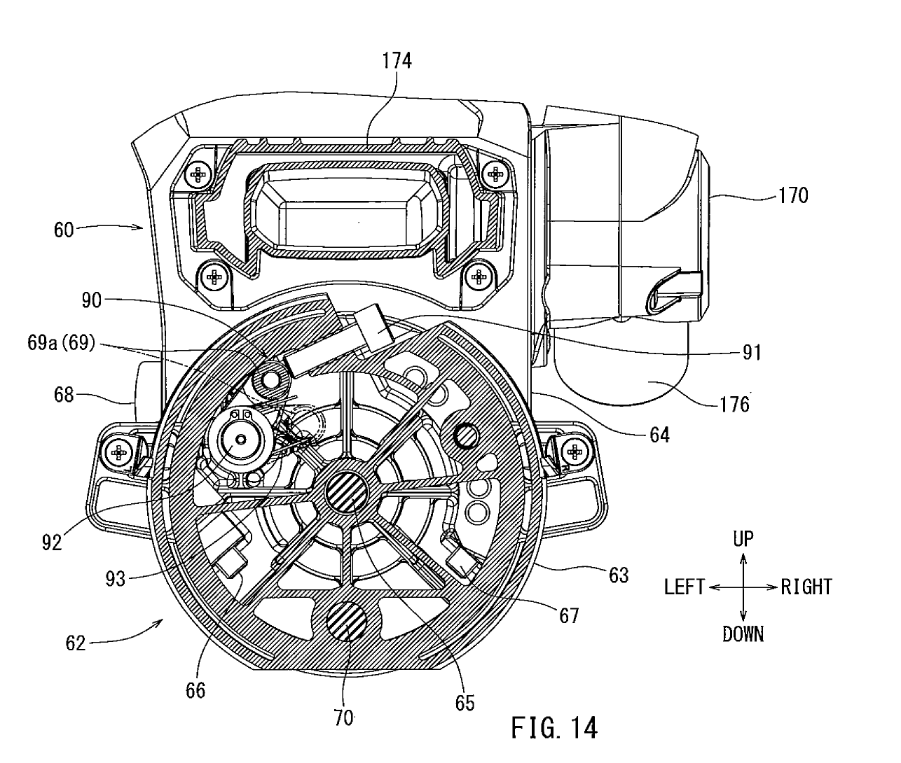

FIGS. 13, 14 and 17 show the right-angled positioning mechanism 90 in detail. The right-angled positioning mechanism 90 includes a right-angled positioning bolt 91, a right-angled positioning release button 68 and a right-angled positioning portion 69. The right-angled positioning bolt 91 is fastened to an upper part of the inclination-receiving portion 63. The right-angled positioning portion 69 is arranged forward relative to the right-angled positioning bolt 91 in a fastening direction thereof. Furthermore, the right-angled positioning portion 69 is supported on the side of the inclination-supporting portion 64. The right-angled positioning portion 69 is supported so as to be tiltable in the up-to-down direction via a supporting shaft 92. The right-angled positioning portion 69 is biased by a torsion spring 93 in a direction where a contact portion 69a, which is provided in a tilting tip end portion of the right-angled positioning portion 69, is biased in the upward direction (in a counterclockwise direction in FIG. 14).

As shown in FIG. 17, an engagement portion 69b is provided on the left side of the right-angled positioning portion 69. The right-angled positioning release button 68 is arranged on the left side of the engagement portion 69b. The right-angled positioning release button 68 is provided on the left side of the inclination-supporting portion 64. Furthermore, the right-angled positioning release button 68 moves in the left-to-right direction. The right-angled positioning release button 68 is biased by a compression spring 94 toward a left-side right-angled positioning position pushing outward (a position shown by a solid line in FIG. 17). In a state where the right-angled positioning release button 69 is pushed outward and positioned at the left-side right-angled positioning position by the biasing force of the compression spring 94, the right-angled positioning portion 69 is positioned by the biasing force of the torsion spring 93 at a right-angled positioning position thereof that is shown by a solid line in FIG. 14. By moving (tilting) the main body supporting arm 61 and eventually the cutting device main body 100 from the left to the right (in a clockwise direction in FIG. 14) and contacting the contact portion 69a of the right-angled positioning portion 69, which is located at the right-angled positioning position thereof: the main body supporting arm 61 and eventually the cutting device main body 100 can be positioned at the right-angled cutting position.

When the right-angled positioning release button 68 is pressed inward to a right-side release position (a position shown by a two-dot chain line in FIG. 17) against the compression spring 94, a tip end of the right-angled positioning release button 68 contacts the engagement portion 69b and be pushed in the rightward direction. By pushing the engagement portion 69b in the rightward direction, the right-angled positioning portion 69 moves to the release position that is shown by the two-dot chain line in FIG. 14. In a state where a pressing operation of the right-angled positioning release button 68 is carried out to position the right-angled positioning portion 69 at the release position, then the right-angled positioning bolt 91 does not contact the contact portion 69a and thus the main body supporting portion 60 and eventually the cutting device main body 100 can be passed though the right-angled positioning position and tilted to the right side. When the cutting device main body 100 is tilted from the right-angled cutting position to the left side, the contact portion 69a of the right-angled positioning portion 69 is displaced in a direction to be separated away from the right-angled positioning bolt 91 in the leftward direction and thus the release operation of the right-angled positioning mechanism 90 is not needed.

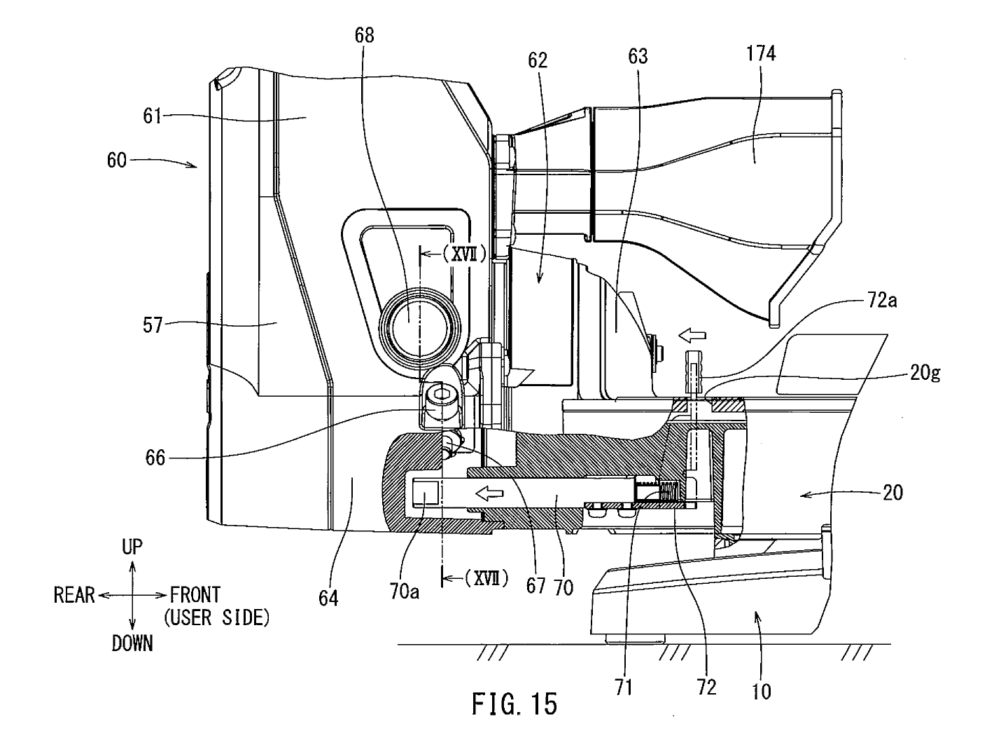

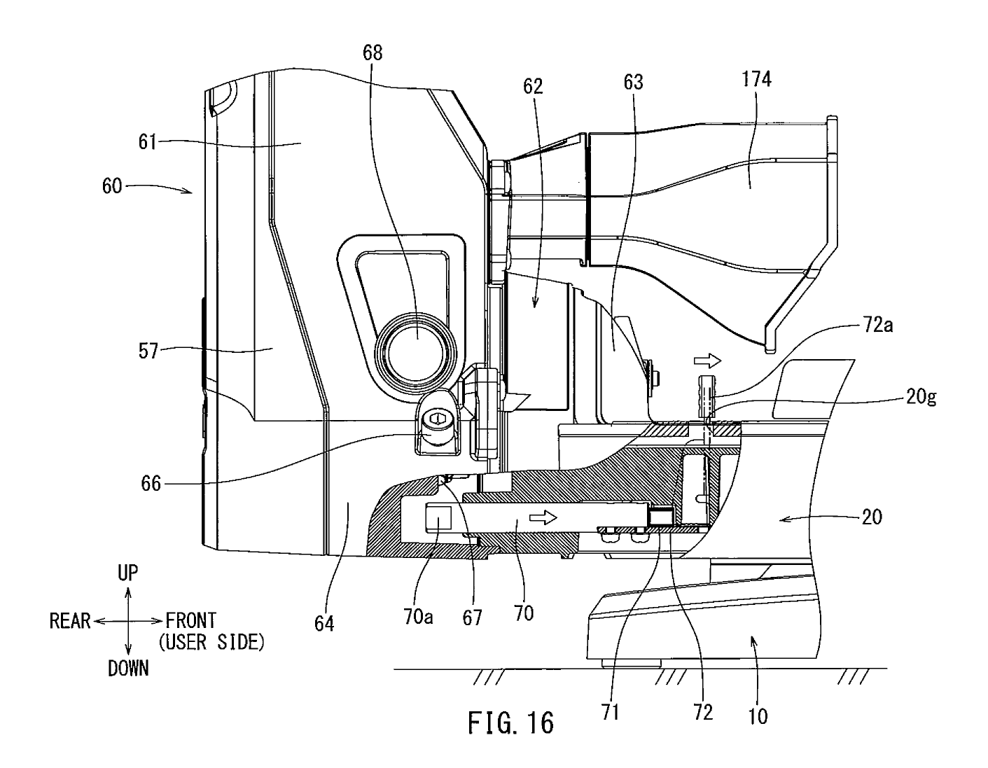

FIGS. 15 to 18 show a detail of the inclination (oblique) positioning mechanism 62. As shown in FIG. 17, inclination-stopper bolts 66, 67 is provided on both the left-to-right side of the inclination-supporting portion 64. Each tip end of the inclination-stopper bolts 66, 67 is fastened obliquely in the downward direction. An inclination-positioning rod 70 is provided at the lower of the inclination-receiving portion 63. As shown in FIGS. 15 and 16, the inclination-positioning rod 70 is supported by the rear portion of the table 20 so as to be displaceable in the front-to-rear axial direction. The inclination-positioning rod 70 is biased by a compression spring 71 in a direction to move to a rear-side 45° positioning position. A rear portion of the inclination-positioning rod 70 is located at a position that the left and right inclination-stopper bolts 66, 67 face (in the forward direction along the axial direction of the inclination-stopper bolt 66, 67).

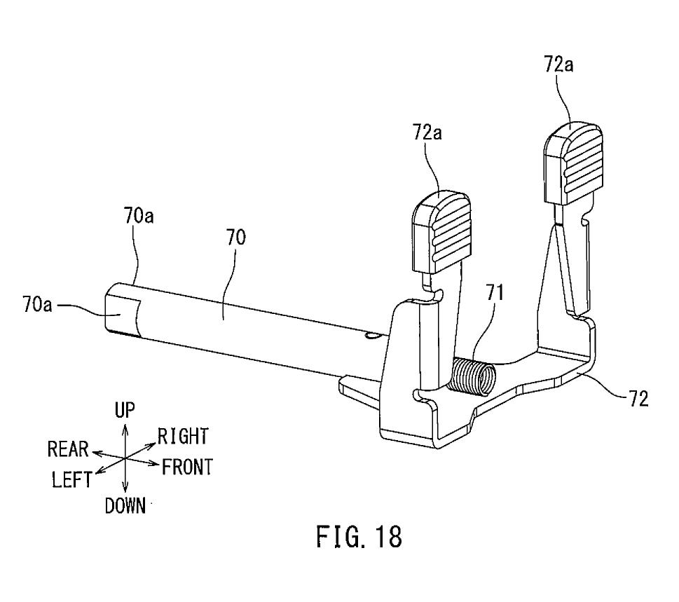

As shown in FIG. 18, an operation bracket 72 is attached to the front portion of the inclination-positioning rod 70. FIG. 18 shows the inclination-positioning rod 70 and the operation bracket 72, respectively as a simple component. A pair of operation knobs 72a are integrally formed in the upper portion of the operation bracket 72, which is used as an operation member for changing an inclination angle. As shown in, for example, FIGS. 2 and 7, each of the left and right operation knob 72a protrudes from the upper surface of the table 20 in the upward direction via an insertion window 20g provided in the rear of the table 20. Each of the left and right insertion windows 20g, respectively, is formed in a rectangular shape for insertion of the operation knob 72a and symmetric arrangement with respect to a central line of the table 20. A length of each insertion window 20g in the front-to-rear direction is configured such that each operation knob 72a can be moved between a front-side 48° positioning position and a rear-side 45° positioning position. The user of the tabletop cutting device 1 can move the inclination-positioning rod 70 in the front-to-rear direction by picking the left or right operation knob 72a with his or her fingers and moving it in the front-to-rear direction.

As shown in FIG. 15, the operation knob 72a is biased in the rearward direction due to a biasing force of the compression spring 71, and said biased position of the operation knob 72a is an initial position. Because of this configuration, the inclination-positioning rod 70 is retained at the rear-side 45° positioning position by the biasing force of the compression spring 71. FIG. 7 shows the initial position of the operation knob 72a, and FIG. 15 shows the corresponding 45° positioning position of the inclination-positioning rod 70. An operation, by which the inclination-positioning rod 70 is moved to the 48° positioning position and the operation knob 72a is moved in the forward direction, is made against the compression spring 71.

As shown in FIGS. 15, 16 and 18, two contact portions 70a, each having a flat surface, are provided at the rear of the inclination positioning rod 70, wherein the two contact portions 70a are parallel to each other. By moving the inclination-positioning rod 70 in the front-to-rear direction, the contact portions 70a also concomitantly move in the front-to-rear direction. FIG. 15 shows that the inclination-positioning rod 70 is positioned to the rear-side 45° positioning position by the biasing force of the compression spring 71. In this state, the contact portions 70a are offset in the rearward direction from the vertical axis line of the left and right inclination-stopper bolts 66, 67. Because of this configuration, when cutting device main body 100 is tilted (inclined) from the right-angled cutting position in the leftward or rightward direction, and eventually the main body supporting arm 61 is tilted (inclined) in the leftward or rightward direction, either one of the left and right inclination-stopper bolts 66, 67 contacts an outer circumferential surface of the inclination-positioning rod 70. Through the contact of either one of the left and right inclination-stopper bolts 66, 67 with the outer circumferential surface of the inclination-positioning rod 70, the cutting device main body 100 is positioned at a position in which it is tilted (inclined) by 45° in the leftward or rightward direction.

As shown in FIG. 16, by moving the left or right operation knob 72a with a finger tip in the forward direction (in the front direction), the inclination-positioning rod 70 is moved frontward to the 48° positioning position against the biasing force of the compression spring 71. When the inclination-positioning rod 70 is moved to the front-side 48° positioning position, the contact portion 71a is positioned in the forward direction along the vertical axial direction of the left or right inclination-stopper bolts 66, 67. Because of this configuration, when the cutting device main body 100 is inclined from the right-angled cutting position in the leftward or rightward direction and eventually the main body supporting arm 61 is inclined in the leftward or rightward direction, the left or right inclination-stopper bolt 66, 67 contacts the respective contact portion 70a of the inclination-positioning rod 70. Through the contact of the respective contact portion 70a of the inclination-positioning rod 70 with the left or right inclination-stopper bolt 66, 67, the cutting device main body 100 is positioned at a position in which it is tilted (inclined) by 48° in the leftward or rightward direction.

As shown in FIG. 17, when the cutting device main body 100 is tilted (inclined) in the leftward direction, the left-side inclination-stopper bolt 66 contacts (abuts) the inclination-positioning rod 70 positioned at the 45° or 48° inclined positions. When the cutting device main body 100 is tilted (inclined) in the rightward direction, the right-side inclination-stopper bolt 67 contacts the inclination-positioning rod 70 positioned at the 45″ or 48° inclined positions. In this way, the inclination-positioning rod 70 for positioning the cutting device main body 100 at the 45° or 48° inclined angle in the leftward or rightward direction can be changed to the 45° or 48° positioning position by manipulation of the operation knobs 72a. The operation knobs 72a are arranged in front of an outer circumferential edge of the table 20 or in front of a rear end of an imaginary circle that passes the outer circumferential edge. Furthermore, the operation knobs 72a are also arranged on a user side (front side) relative to the inclination positioning mechanism 62. On the other hand, in the prior art such as, for example, Japanese Laid-Open Patent Publication No. 2011-41999 and Japanese Laid-Open Patent Publication No. 2014-138961, this type of change lever is arranged on the rear surface side or the side surface side of the main body supporting arm 61. In comparison with these conventional configurations, the operation knobs 72a according to the present embodiment are arranged at a position closer to the user (at a rear upper surface of the table). Because of this configuration, the user can easily operate the operation knobs 72a in a comfortable manner. In this respect, operability of the tabletop cutting device can be improved. Furthermore, the operation knobs 72a are arranged on both the left and right sides and thus the user can operate the operation knobs 72a, using his or her left or right hand. Furthermore, when the cutting device main body 100 is tilted (inclined) in the leftward direction, a wide space may be created near the right-side operation knob 72a. On the other hand, when the cutting device main body 100 is tilted (inclined) in the rightward direction, another wide space may be created near the left-side operation knob 72a. Because of this configuration where either side's knob 72a can be used, the operation knobs 72a are able to be operated by the user in either case.

[Inclination Fixing Mechanism 50 of the Cutting Device Main Body 100]

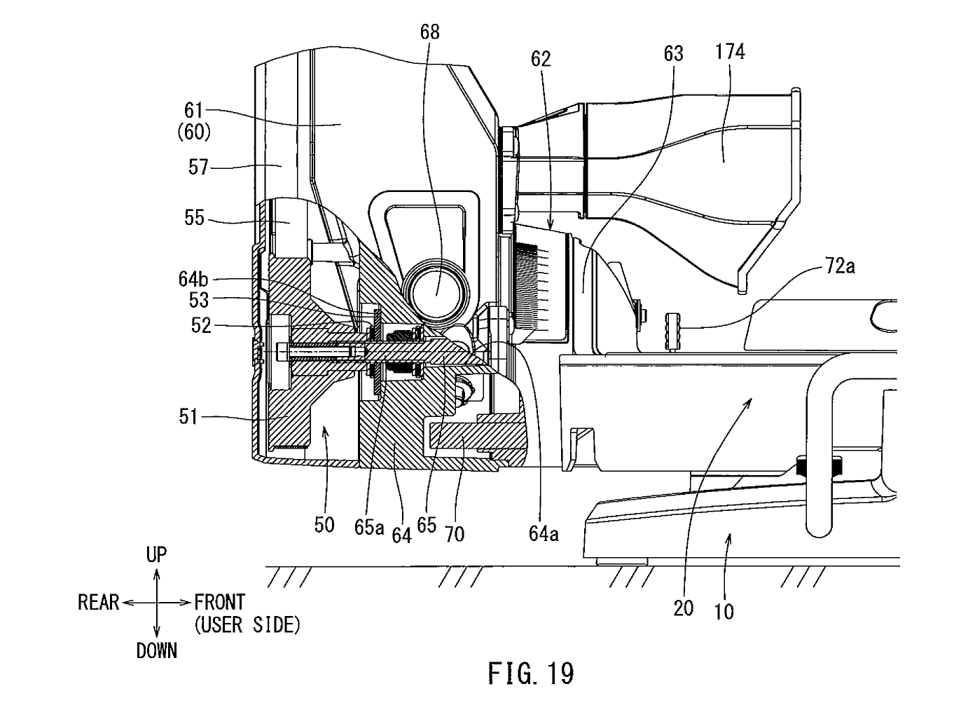

After the cutting device main body 100 is positioned by the right-angled positioning portion 69 or the inclination-positioning rod 70, the right-angled cutting position or the left-and-right inclination position of the cutting device main body 100 can be fixed by an inclination fixing mechanism 50, which will be discussed below. FIGS. 19 to 21 show the inclination fixing mechanism 50 in detail. A left/right inclination shaft 65 is formed integrally with the inclination-receiving portion 63 protruding therefrom in the rearward direction. The left/right inclination shaft 65 protrudes from the rear surface of the inclination-supporting portion 64 via an insertion hole 64a in the rearward direction. A screw shaft portion 65a is provided at the rear of the left/right inclination shaft 65. A first pulley 51 is joined to the screw shaft portion 65a. When the first pulley 51 rotates with respect to the screw shaft portion 65a, the first pulley 51 moves about its rotational axis (in the front-to-rear direction). When the first pulley 51 is fastened with respect to the screw shaft portion 65a, the first pulley 51 is pressed by a step portion 64b of the inclination-supporting portion 64 via a thrust bearing 52 and a flange 53. When the first pulley 51 is fastened to the screw shaft portion 65a and pressed by the step portion 64b, the inclination-supporting portion 64 is fixed to the inclination-receiving portion 63 and thus a left-to-right inclination position of the main body supporting arm 61 is fixed. In contrast, when fastening of the first pulley 51 is loosened with respect to the screw shaft portion 65a, the inclination-supporting portion 64 is still rotatable with respect to the inclination-receiving portion 63 and thus the main body supporting arm 61 can be inclined in the left-and-right direction.

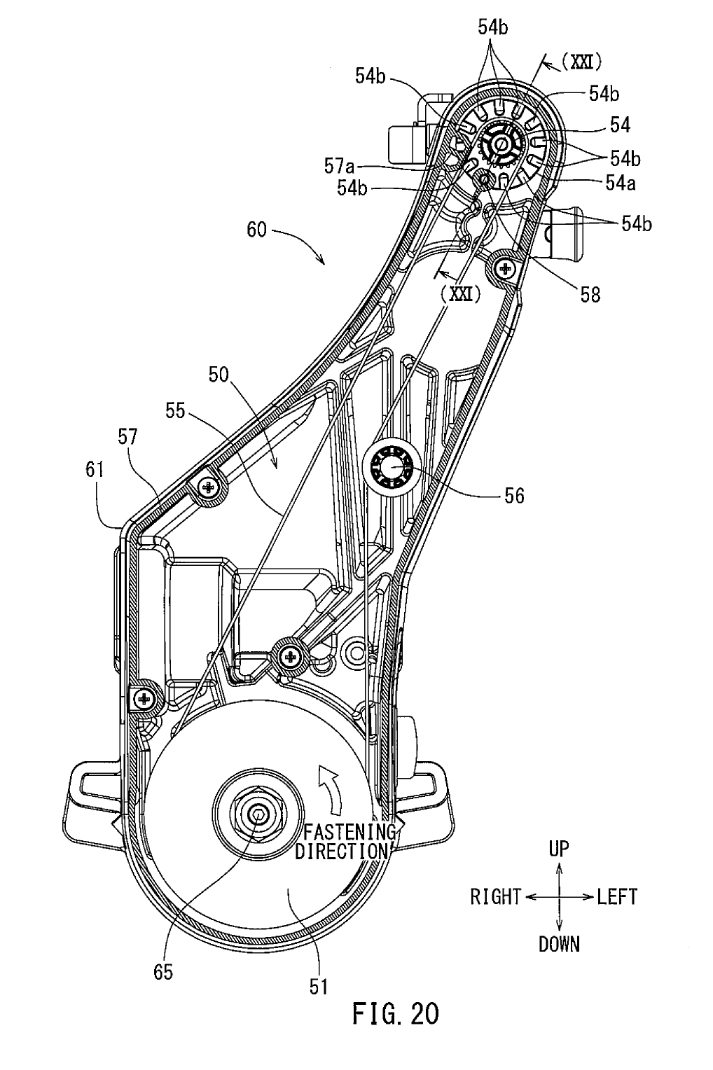

As shown in FIG. 20, a second pulley 54 is rotatably supported on the upper portion of the main body supporting arm 61. A transmission belt 55 is fit around both the first pulley 51 and the second pulley 54. Toothed pulleys are used for the first pulley 51 and the second pulley 54. Accordingly, a toothed belt is used for the transmission belt 55. The first pulley 51 and the second pulley 54 engage with the transmission belt 55, which can reliably transmit power without slipping upon contact with the pulleys 51 and 54. An idler 56 is rotatably supported at an intermediate portion of the transmission path in the main body supporting arm 61. An appropriate tension of the transmission belt 55 is retained by the positioning of the idler 56. Owing to the appropriate tension of the transmission belt 55 caused by the presence of the idler 56, tooth skipping of the first pulley 51 and the second pulley 54 with respect to contact with the transmission belt 55 can be prevented. In this respect, power can be reliably transmitted.

An arm cover 57 made from resin is attached to the rear surface side of the main body supporting arm 61. The arm cover 57 is attached to the main body supporting arm 61 so as to cover approximately the entirety of the rear surface of the main body supporting arm 61. The power transmission path of the transmission belt 55 between the first pulley 51 and the second pulley 54 is covered by the arm cover 57, which can isolate the power transmission assembly, preventing interference or jamming of other components with respect to the first pulley 51, the second pulley 54, and the transmission belt 55. Furthermore, these members 51, 54, and 55 can be protected from dust etc. by the arm cover 57.

As shown in FIG. 20, a belt pressing portion 57a is provided at the upper region of the main body supporting arm 61. The belt pressing portion 57a is located on the right side of the second pulley 54. In the present embodiment, the belt pressing portion 57a is formed integrally with the arm cover 57. The belt pressing portion 57a protrudes inwardly from the wall portion of the arm cover 57. As shown in FIG. 20, the belt pressing portion 57a is pressed by the outward facing side of the transmission belt 55 (the side facing opposite the pulley teeth). Furthermore, the belt pressing portion 57a is arranged to the front of the fastening rotation direction (counterclockwise direction in FIG. 20, clockwise direction viewed from the user side) of the second pulley 54. FIG. 20 indicates the fastening rotation direction of the first pulley 51 about the screw shaft portion 65a of the left/right inclination shaft 65 with a void arrow. By rotating the second pulley 54 in the same direction as that of the void arrow, a left-to-right inclination position of the main body supporting arm 61 can be fixed with respect to inclination-receiving portion 63, and eventually a left-to-right inclination position of the cutting device main body 100 can be fixed. Because of this configuration, flexure of the transmission belt 55 may be easily occur toward the front of the fastening rotation direction of the second pulley 54 (on the right side of the second pulley 54 in FIG. 20). Hence, the belt pressing portion 57a can prevent the flexure from occurring. By preventing this type of flexure of the transmission belt 55 with respect to the second pulley 54, tooth skipping of the transmission belt 55 with respect to the second pulley 54 can be prevented, which can help the device reliably transmit power.

According to the belt pressing portion 57a, the occurrence of the flexure of the transmission belt 55 can be prevented even in a narrow area where the idler cannot be arranged. If the belt pressing portion 57a is provided at a plurality of places, the flexure of the transmission belt 55 can be more reliably prevented. Furthermore, the belt pressing portion 57a can also be provided on the side of the main body supporting arm 61.

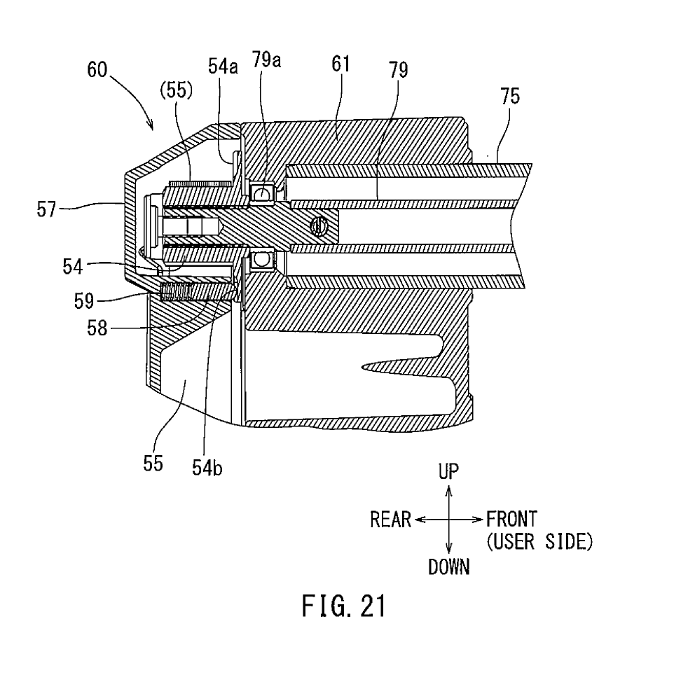

As shown in FIGS. 20 and 21, the second pulley 54 is provided with a flange 54a. A plurality of engagement recesses 54b are provided on the rear surface of the flange 54a. The plurality of engagement recesses 54b are arranged at equally spaced radial intervals along a concentric circle having its radial center coinciding with a rotational center of the second pulley 54. A single engagement pin 58 is provided at the upper portion of the arm cover 57 so as to be biased in a protruding direction by a compression spring 59. The engagement pin 58 that is biased in the protruding direction by the compression spring 59 is pressed toward an engagement recess 54b of the second pulley 54. By elastically pressing the engagement pin 58 to the engagement recess 54b with the compression spring 59, a click feeling in the rotational direction of the second pulley 54 can be obtained.

As shown in FIG. 2, two slide bars 75 and 76 are supported on the upper portion of the main body supporting arm 61. The two slide bars 75 and 76 are fixed to the main body supporting arm 61 so as to extend lengthwise from the upper front surface of the main body supporting arm 61 in the forward direction, and the front ends of the two bars reaches an upper center of the table 20. The two slide bars 75 and 76 are supported parallel to each other separated by a predetermined length in the up-to-down direction. The front ends of the two slide bars 75 and 76 are joined by a connection member 78 so as to be spaced apart with respect to each other by the predetermined length. A main body slider 77 is supported so as to be slidable in the front-to-rear direction via the upper and lower slide bars 75 and 76. The cutting device main body 100 is supported by the main body slider 77. The cutting device main body 100 is supported so as to be slidable in the front-to-rear direction via the main body slider 77, the upper slide bar 75, and the lower slide bar 76.

As shown in FIG. 2, a pipe material such as a steel pipe is used for the upper and lower slide bars 75 and 76. A transmission rod 79 is inserted in the inner circumference of the upper slide bar 75. The transmission rod 79 is supported so as to be rotatable around an axis thereof via a rear-side bearing 79a and a front-side bearing 79b. The rear-side bearing 79a is supported by the main body supporting arm 61. The front-side bearing 79b is supported by the connection member 78. The second pulley 54 is joined to the rear portion of the transmission rod 79. The second pulley 54 rotates together with the transmission rod 79.

An operation knob 73 is joined to the front portion of the transmission rod 79. By rotating the operation knob 73 in the clockwise direction, the second pulley 54 can be rotated in the fastening direction (in the fastening direction of the first pulley 51 with respect to the screw shaft portion 65a) via the transmission rod 79. The user can rotate the second pulley 54, while directly receiving the click feeling, which can be obtained by the click mechanism provided in the second pulley 54, at a predetermined angle with respect to the rotation of the operation knob 73. The rotation of the second pulley 54 is transmitted to the first pulley 51. By rotating the operation knob 73, the first pulley 51 can be rotated, and accordingly a left-to-right inclination position of the main body supporting arm 61 and eventually the cutting device main body 100 can be fixed.

According to the above-described inclination fixing mechanism 50, the inclination fixing mechanism 50 can be remotely operated by the rotation of the operation knob 73. The operation knob 73 is located approximately at the upper center of the table 20, and thus the user can easily operate the operation knob 73 without a need to stretch his/her hand largely and take a limiting posture. Furthermore, the click feeling can be obtained with respect to the rotation by the engagement pin 58 that is spring-biased by the compression spring 59 (the click mechanism). Because of this configuration, the user can operate the operation knob 73 while receiving the click feeling. In this respect, in comparison with the prior art such as, for example, Japanese Laid-Open Patent Publication No. 2015-150633, operability of the inclination fixing mechanism 50 is improved. Furthermore, flexure of the transmission belt 55 at the front side of the fastening rotation direction of the second pulley 54 can be prevented by the belt pressing portion 57a, which can prevent tooth skipping of the transmission belt 55 with respect to the second pulley 54.

[Cutting Device Main Body 100]

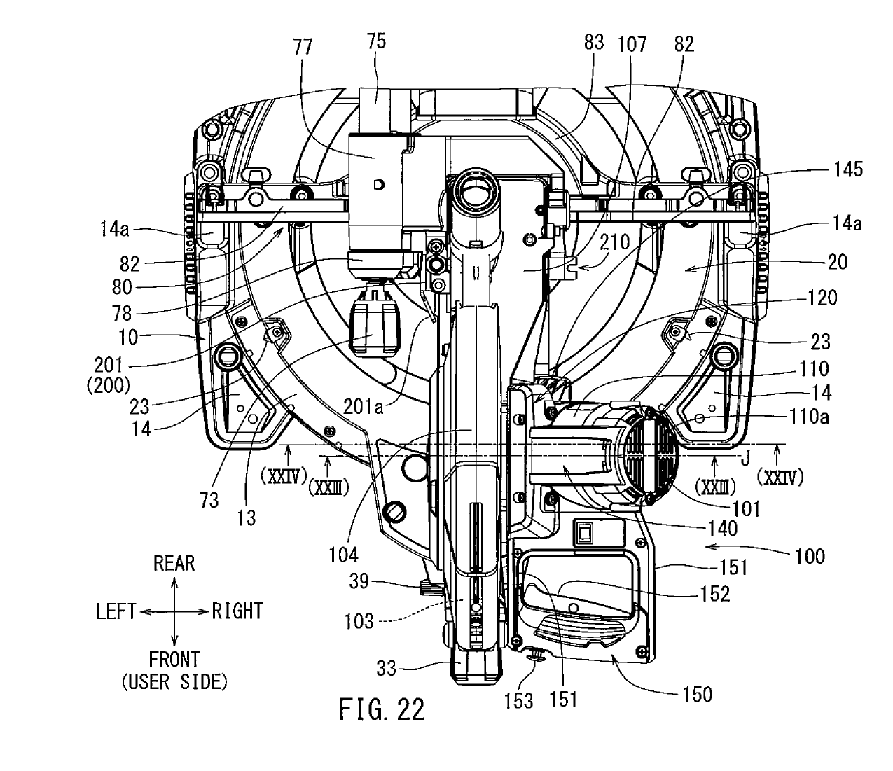

The cutting device main body 100 is supported so as to be slidable in the front-to-rear direction via the two slide bars 75, 76 of the main body supporting portion 60. FIGS. 22 to 25 show a detail of the cutting device main body 100. The cutting device main body 100 includes the circular cutting blade 102 that rotates by an electric motor 101, which can be driven by an AC power source, as a driving force. An upper half periphery of the cutting blade 102 is covered by a fixing cover 103. A lower half periphery of the cutting blade 102 is covered by a movable cover 104. As shown in FIG. 23, the movable cover 104 is supported on the left-side surface of the fixing cover 103 so as to be rotatable (so as to be able to open and close in the up-to-down direction) via a bearing (ball bearing) 104 that is attached to an outer circumference side of a boss portion 104a. The movable cover 104 is opened and closed in accordance with the up-to-down movement of the cutting device main body 100. When the movable cover 104 is opened, a lower portion of the cutting blade 103 is exposed. The exposed portion of the cutting blade 103 is cut into the material to be cut (workpiece W). When the cutting device main body 100 is positioned at a top dead center (a state shown in FIGS. 1 to 5), the movable cover 104 is completely closed. As the cutting device main body 100 moves downward from the top dead center to a bottom dead center, the movable cover 104 is gradually opened. When the cutting device main body 100 moves to the bottom dead center (a state shown in FIG. 22), the movable cover 104 is completely opened.

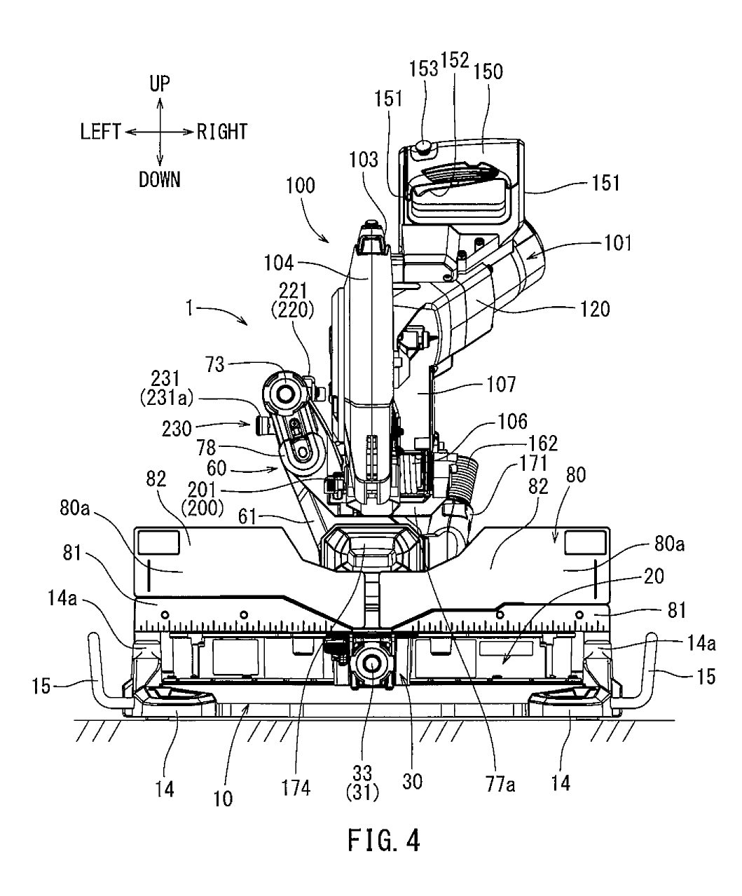

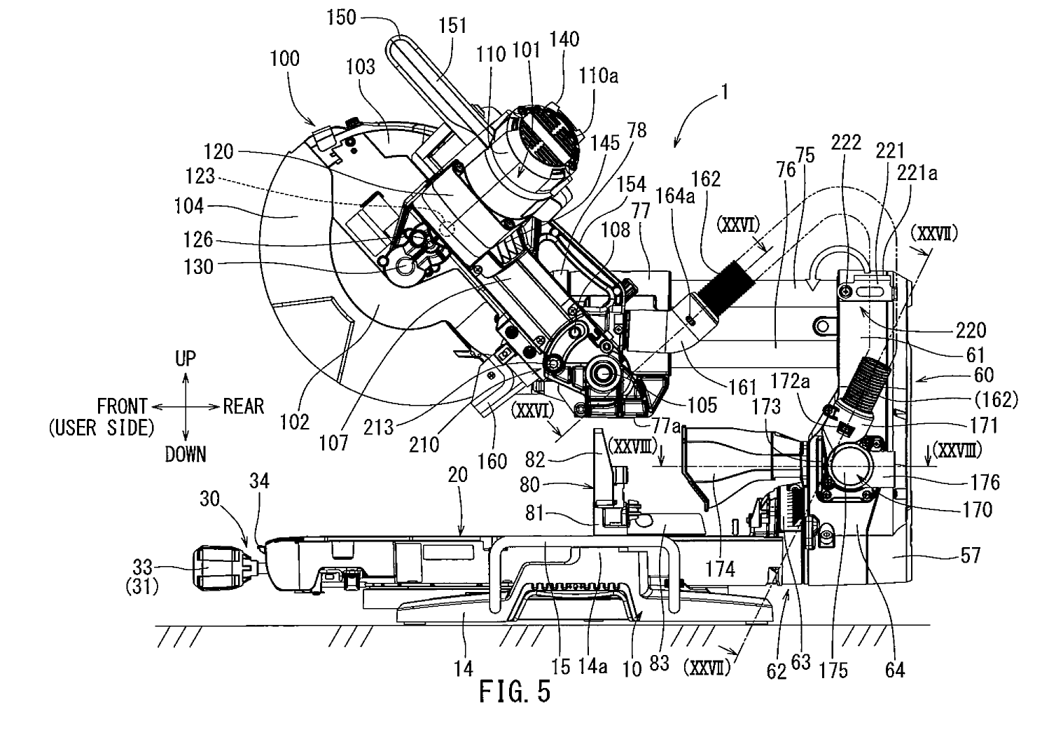

As shown in FIGS. 4 and 5, a base 107 is formed integrally with the fixing cover 103 at the rear thereof. The base 107 extends in the rearward direction. Furthermore, a main body supporting portion 77a having a fork shape is provided on the right side of the main body slider 77. The rear portion of the base 107 is inserted into the main body supporting portion 77a and joined so as to be swung along the up-to-down direction via an up-to-down swing shaft 105. Because of this configuration, the cutting device main body 100 is supported so as to be swung along the up-to-down direction with respect to the main body slider 77. The cutting device main body 100 is swung along the up-to-down direction around the up-to-down swing shaft 105. The cutting device main body 100 is biased in a direction where it can be returned to an upper-side stand-by position by a torsion spring 106 that is attached around the up-to-down swing shaft 105 (a part of the torsion spring 106 is seen in FIG. 4).

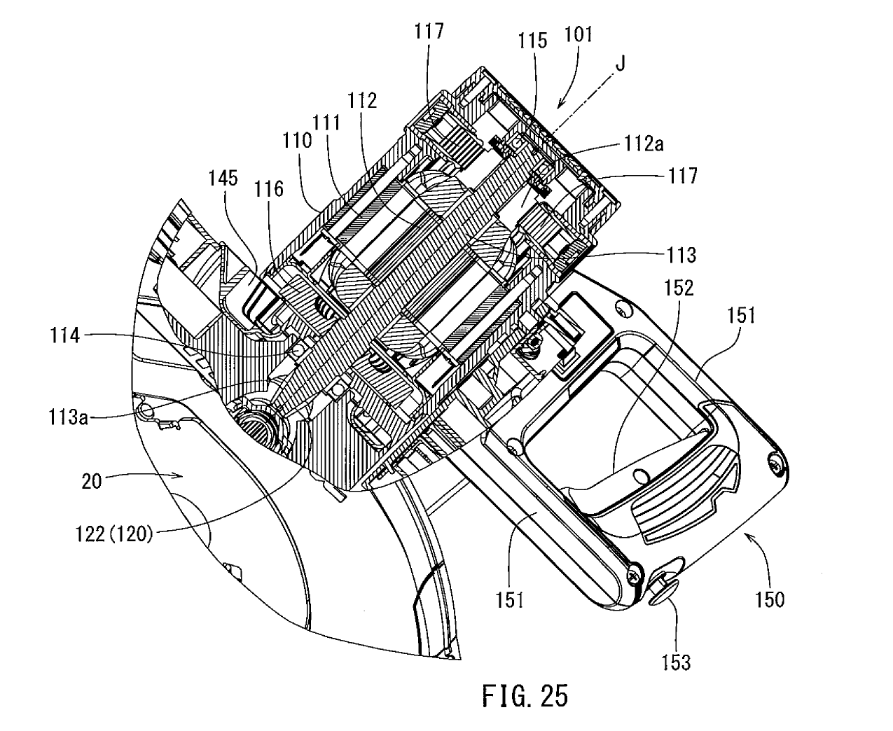

As shown in FIGS. 23 and 25, the electric motor 101 is configured such that a stator 111 and a rotor 112 are housed in a tubular motor housing 110. The stator 111 is fixed on the inner peripheral side of the motor housing 110. The rotor 112 is rotatably supported on the inner peripheral side of the stator 111. The rotor 112 is attached to a motor shaft 113. The motor shaft 113 is rotatably supported via a front-side bearing 114 and a rear-side bearing 115 along a direction of the motor axis J. A cooling fan 116 is attached to the motor shaft 113 on the front side in the direction of the motor axis J (lower left). A commutator 112a is located on the rear side in the direction of the motor axis J of the rotor 112 (upper right). Two carbon brushes are brought into slidably contact with the commutator 112a from opposite sides relative each other.

As shown in FIG. 22, a plurality of intake ports 110a are provided on the rear surface of the motor housing 110 in a plane perpendicular to the direction of the motor axis J. When the electric motor 101 runs and the cooling fan 116 rotates, outside air is introduced to the inside of the motor housing 110 via the intake ports 110a. The outside air (cooling air) introduced from the intake ports 110a flows toward the front side in the direction of the motor axis J, which can cool the stator 111 and the rotor 112 etc.

The electric motor 101 is attached in such a manner that the rear side of the electric motor 101 is tilted (inclined) in the upward and rightward direction along the direction of the motor axis J. As shown in FIG. 23, when the cutting device main body 100 is positioned at the right-angled cutting position in which the cutting blade 102 is placed perpendicular to the upper surface of the table 20, the motor axis J of the electric motor 101 is not parallel to the upper surface of the table 20 but is rather tilted (inclined) with respect to the upper surface of the table 20. By arranging the electric motor 101 in this tilted (inclined) manner, an inclination angle of the cutting device main body 100 in the rightward direction can be configured to be large.

The electric motor 101 is joined to a backside (right side) of the fixing cover 103 via a gear head 120. The gear head 120 is configured such that a double reduction gear train is housed in the gear housing 121. The gear housing 121 is formed integrally with the backside of the fixing cover 103. An output gear 113a is provided at a tip end of the motor shaft 113 of the electric motor 101. The output gear 113a engages with a first driven gear 122. The first driven gear 122 is arranged on a first driven shaft 123. On the left side of the first driven gear 122, a second driven gear 124 is arranged on the first drive shaft 123. The first driven shaft 123 is rotatably supported by the gear housing 121 via bearings 123a and 123b.

A second driven gear 124 is engaged with a third driven gear 125. The third driven gear 125 is arranged on the second driven shaft 126. The second driven shaft 126 is rotatably supported by the gear housing 121 via bearings 126a and 126b. The second driven shaft 126 is parallel to the first driven shaft 123. The third driven gear 125 engages with a fourth driven gear 127. The fourth driven gear 127 is arranged on a spindle 130. The spindle 130 is rotatably supported by a lower portion of the gear housing 121 via bearings 130a and 130b. The spindle 130 is parallel to the first driven shaft 123 and the second driven shaft 126.

The spindle 130 protrudes inside the fixing cover 103. The cutting blade 102 is also fixedly attached to the protruding portion of the spindle 130. The cutting blade 102 is attached to the spindle 130 by fastening a cutting blade fixing screw 134 with its center portion being securely held by an outer flange 131 and an inner flange 132.

A controller housing portion 140 is provided at the upper portion of the electric motor 101. A controller 141 for controlling the electric motor 101 is housed in the controller housing portion 140. The controller 141 controls the electric motor in such a manner that a constant rotation or a so-called soft-start can be performed. The controller 141 is cooled by a portion of the outside air (motor cooling air) flowing into the motor housing 110 by the rotation of the cooling fan 116, as described earlier. As shown in FIGS. 5, 6 and 22, an exhaust port 145 for exhausting the motor cooling air is provided on the rear side of the gear head 120.

A handle 150 that the user can hold is provided on the front side of the electric motor 101 when viewed from the user side. The handle 150, which can be held by the user in a horizontal manner, is arranged approximately parallel to the left-to-right axis about which the cutting blade 102 rotates (the left-to-right axis of the spindle 130). Both the left and right side of the handle 150 are joined to the front side of the electric motor 101 via legs 151. A switch lever 152 is arranged on the rear surface of the handle 150. By pulling the switch lever 152 forward, where the handle 150 is held by the user's hand, the electric motor runs and the cutting blade 102 rotates. Additionally, a lock-off switch 153 is provided on the front side of the handle 150. Only when the lock-off switch is pulled out so as to turn the lock off, the switch lever 152 can be pulled by the user.

As shown in FIG. 5, a carrying handle 154 for carrying the tabletop cutting device 1 is provided on the rear side of fixing cover 103. The carrying handle 154 straddles an upper rear surface of the fixing cover 103 as well as the rear of the base 107. The carrying handle 154 is configured to extend approximately horizontally when the cutting device main body 100 is locked at the bottom dead center by a swing lock mechanism 210 that will be discussed infra. When the user configures the tabletop cutting device 1 with the cutting device main body 100 locked at the bottom dead center, the user can easily carry the tabletop cutting device 1 in a well-balanced manner without the cutting device 1 tilting in either the front-to-rear direction or in the left-to-right directions.

[Dust Collection Hose]

As shown in FIGS. 1 and 2, an arrow 103a for indicating the rotation direction of the cutting device 102 is shown on the left side of the fixing cover 103. The cutting blade 102 rotates in a clockwise direction when viewed from the left side. Because of this configuration, cutting dust produced by the cutting work is blown up from the upper surface of the workpiece W on the rear side of the fixing cover 103. As shown in FIG. 5, a dust guide 160 for receiving the blown-up dust is attached to the lower rear portion of the base 107. Furthermore, a main body side connection port 161 for connecting a dust collection hose 162 is provided on the rear of the carrying handle 154, at the upper rear portion of the base 107. The main body side connection port 161 has a sleeve shape, and the interior of the main body side connection port 161 communicates with the dust guide 160 via the interior of the base 107. The dust received by the dust guide 160 is blown up toward the interior of the main body side connection port 161 via the interior of the base 107. A dust collection hose 162 is connected to the main body side connection port 161 via the connection member 163. FIG. 5 shows a connection configuration of the dust collection hose 162 and the connection member 163 with respect to the main body side connection port 161.

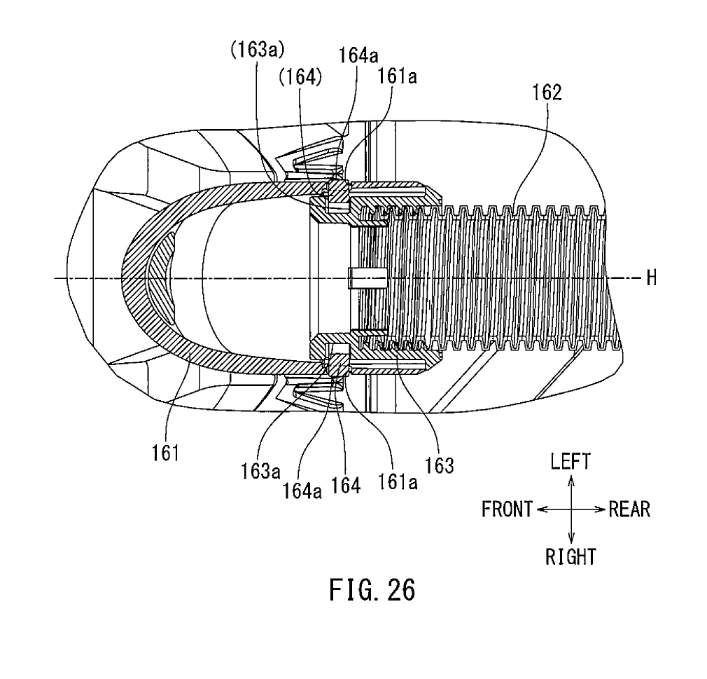

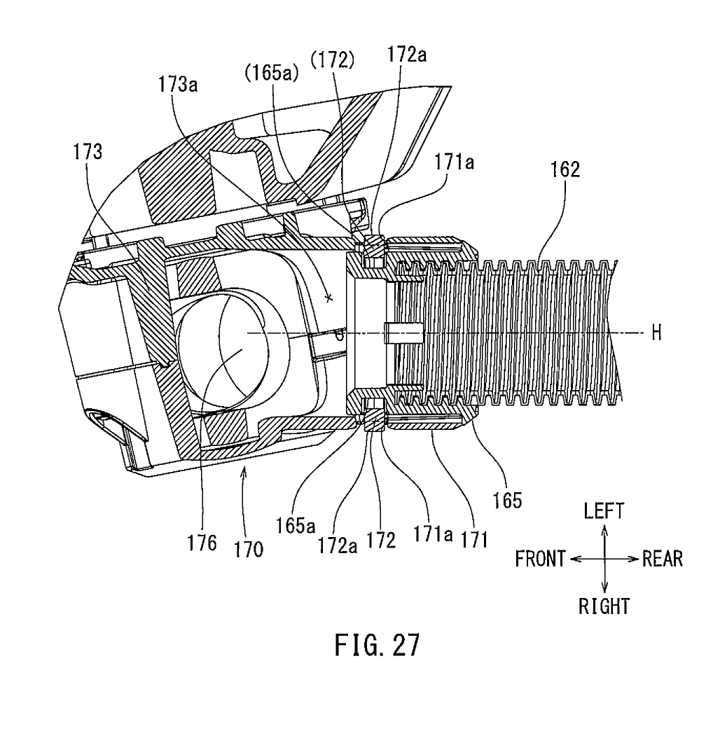

The dust collection hose 162 is a bellows-shaped hose having adequate expandability and flexibility. Furthermore, the dust collection hose 162 is connected to a relay duct 170 serving as a hose intermediate connection port provided on the right side of the main body supporting portion 60. The dust collection hose 162 is connected to the main body side connection port 161 and the relay duct 170 via an arrangement path in such a way that, for example, the dust collection hose 162 is largely bent in the upward direction as shown in FIG. 5. A length of the dust collection hose 162 between the main body side connection port 161 and the relay duct 170 (the total length of the dust collection hose 162 in the present embodiment) is configured such that the cutting device main body 100 can be moved over an entire swing range along the up-to-down direction and an entire slide range in the front-to-rear direction. FIG. 26 shows a connection configuration of the dust collection hose 162 with respect to the main body side connection port 161, and FIG. 27 with respect to the relay duct 170. As shown in FIG. 26, a tubular connection member 163 is attached to an upstream end portion of the dust collection hose 162. The upstream end portion of the dust collection hose 162 is connected to the inner periphery of the connection member 163. A recess 163a with a predetermined width is provided along the entire outer radial periphery of a frontward portion of the connection member 163.

A retention member 164 is attached to the inner periphery of the main body side connection port 161. The retention member 164 is a resin-made annular-shaped interposition member having elasticity in a radially extension direction. An engagement protrusion 164a is provided integrally with the retention member 164 at each of a position in which the length of the outer radial periphery of the retention member 164 is halved. Each of the two engagement protrusions 164a protrudes into a corresponding engagement hole 161a that is similarly provided at a corresponding position in which the main body side connection port 161 is halved along its outer radial periphery. Through contact of the two engagement protrusions 164a with the engagement holes 161a, respectively, the retention member 164 can be retained along the inner periphery of the main body side connection port 161 so as not to be offset in a radial direction and/or axial direction relative to axis H.

The annular-shaped retention member 164 that is retained along the inner periphery of the main body side connection port 161 engages with the recess 163a of the connection member 163. Because of this configuration, the dust collection hose 162 is connected to the main body side connection port 161 so as to be rotatable around the axis H. The connection member 163 can be extracted from the inner periphery of the main body side connection port 161 by pressing the two engagement protrusions 164a deeply into the engagement holes 161a and elastically deforming the retention member 164 in the radially inward contracting direction. In this way, the dust collection hose 162 can be easily extracted from the main body side connection port 161.

As shown in FIG. 27, a connection member 165 is attached to a downstream end portion of the dust collection hose 162 in a similar manner. The downstream end portion of the dust collection hose 162 is connected to a supporting side connection port 171 of the relay duct 170 via a connection member 165. A recess 165a is provided along the entire radial outer periphery of a frontward portion connection member 165. An annular-shaped retention member 172 is attached to the inner periphery of the supporting side connection port 171. An engagement protrusion 172a is formed at each of a position in which the length of the outer periphery of the retention member 172 is halved. Each of the two engagement protrusions 172a protrudes into a corresponding engagement hole 171a that is provided at a corresponding position in which the supporting side connection port 171 is halved along its periphery. Because of this configuration, the retention member 172 can be retained along the inner periphery of the supporting side connection port 171 so as not to be offset in a radial direction and/or axial direction relative to axis H. Accordingly, on the downstream side of the dust collection hose 162 as well as on the upstream side thereof, the dust collection hose 162 is connected to the supporting side connection port 171 so as to be easily rotatable around the axis H with a small external force.

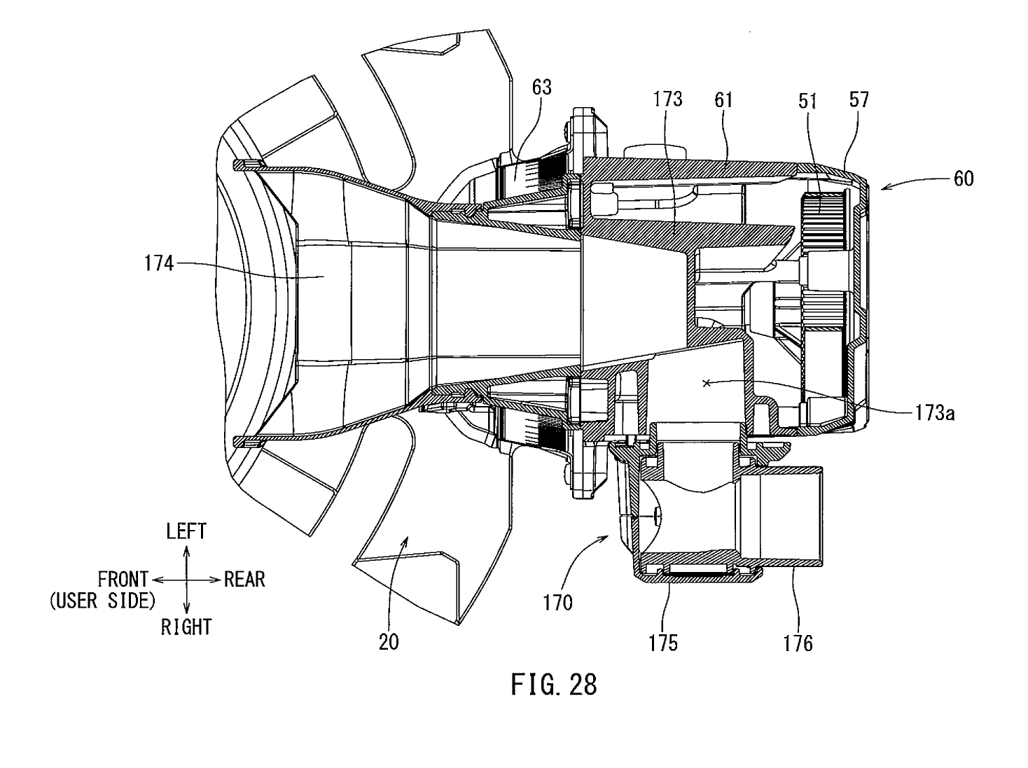

As shown in FIG. 28, the relay duct 170 includes a base 173 that is formed integrally with the main body supporting arm 61 of the main body supporting portion 60. A large-sized dust collection duct 174 is attached to the front portion of the base 173. The dust collection duct 174 faces the rear back side of the positioning fence 80. Hence, dust blown up in the rearward direction of the positioning fence 80 is collected by the dust collection duct 174. An exhaustion nozzle 176 is connected to the right-side portion of the base 173 via a joint 175. As shown in FIG. 5, the aforementioned supporting side connection port 171 is provided on the upper side of the base 173, being slightly tilted (inclined) in the rearward direction.

As shown in FIG. 28, the dust collection duct 174 and the supporting side connection port 171 communicate with the exhaustion nozzle 176 via an inner path 173a of the base 173. The exhaustion nozzle 176 is supported so as to be rotatable in the up-to-down direction about the joint 175. Another hose, which is separately prepared in order to use a dust collector, is connected to the exhaustion nozzle 176.

As discussed above, the upstream side (front side) of the dust collection hose 162 is connected to the main body side connection port 161 so as to be rotatable about the axis H thereof, and also the downstream side (rear side) is connected to the supporting side connection portion 171 so as to be rotatable about the axis H thereof. According to this connection configuration, for example, even when the cutting device main body 100 is swung in the up-to-down direction or slid in the front-to-rear direction to cause the arrangement of the dust collection hose 162 to be changed, both the upstream end portion and the downstream portion of the dust collection hose 162 are rotated around the axis H accordingly and thus any accumulated unnatural bending or torsion, which cause a cross-section of the dust collection hose 162 to be reduced, may not occur in the intermediate path thereof. Because of this configuration, a smooth arrangement path of the dust collection hose 162 is retained and thus an original cross-section thereof can be retained along the entire length of the dust collection hose 162. Thus, high efficiency of collecting the dust can be reliably obtained.

In contrast, in prior art such as, for example, Japanese Laid-Open Patent Publication No. H06-210605, an end portion of the dust collection hose is connected to the connection port in a manner to be non-rotatably fixed around its axis. Because of this configuration, when an arrangement path is changed, unnatural bending or torsion can occur in the arrangement path, which causes a collection path of the dust collection hose having a sufficiently large cross-section might not be obtained. According to the above-discussed connection configuration (rotation connection configuration) of the dust collection hose 162, this problem can be resolved. Furthermore, in the present embodiment, when the tabletop cutting device 1 is placed and retained against a wall in such a manner that the dust collection hose 162 might be interfered with the wall surface, both ends of the dust collection hose 162 can be rotated around the axis H and the arrangement path thereof can be smoothly moved along the wall surface. Because of this configuration, deformation or damage of the dust collection hose 162 can be prevented and durability thereof can be improved.

Instead of retention members 164, 172, a rolling bearing such as a ball bearing or a needle bearing may be used such that the upstream and downstream side portions of the dust collection hose 162 can be configured to rotate around the axis H. Furthermore, it may be possible to remove the main body side connection port 161 and to attach a dust bag or a dust box to the removed tubular port 161, instead of the dust collection hose 162.

[Housing Configuration of an Auxiliary Fence 82]

The positioning fence 80 for positioning the workpiece W on the surface of the table 20 is provided on the upper surface side of the table 20. A front surface of the positioning fence 80 (positioning surface 80a) is located so as to include a rotation center of the table 20 (axis of the rotation shaft 21). By bringing the rear surface of the workpiece W into contact with the positioning surface 80a of the front surface of the positioning fence 80 and positioning said workpiece W in the left-to-right direction, an adequate position for cutting on the upper surface of the table 20 (in the surface direction of the table 20) can be obtained.

The positioning fence 80 is provided with an up-to-down double stage configuration that includes a pair of base portions 81 and a pair of corresponding auxiliary fences 82 with regard to the cutting blade 102. The pair of base portions 81 is formed integrally on the side of their rear surface via a semi-circular shaped connection member 83. The left and right side portions of the base 10 extend from the lower surface of the table 20 in the leftward and rightward direction. Each of the left and right extension portions 14 is provided with a seat portion 14a that rises in the upward direction, respectively. The base portions 81 are be supported along the upper surface of the table 20 straddling the left seat portion 14a as well as the right set portion 14a. FIG. 7 shows a state where the positioning fence 80 is removed. Two auxiliary seat portions 14a are provided on the surface of the base 10. FIG. 7 shows the two auxiliary seat portions 14b that are located along arc-shaped insertion recesses 24 provided in the table 20. The base portions 81 is also supported along the upper surface of the table 20 also by a supporting column (not shown) that is attached to the auxiliary seat portions 14b.

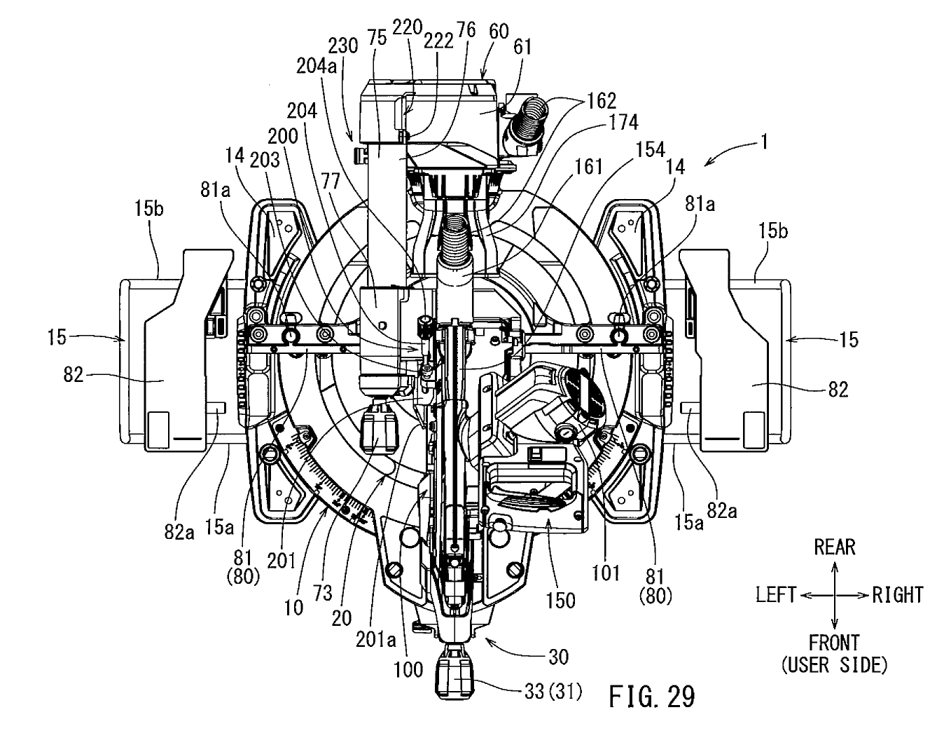

The auxiliary fences 82 are supported flush with the upper side of the base portions 81 (so as to precisely form the front positioning surface 80a). Attaching the auxiliary fences 82 to the upper side of the left-to-right base portions 81 increases the height of the positioning surface 80a, where a workpiece W having a large height can still be precisely positioned, and furthermore enables cutting work to be made in a manner such that the workpiece W is obliquely placed between the upper surface of the table 20 and the positioning surface 80a. The left and right auxiliary fences 82 can be removed from the base portions 81, respectively. When the auxiliary fences 82 are removed, the cutting device main body 100 can be tilted (inclined) in the left-to-right direction at a large angle. FIG. 29 shows that the left and right auxiliary fences 82 are removed from the base portions 81. As shown in FIG. 29, the left and right auxiliary fences 82 that are removed from the base portions 81 are placed (housed) on holder metal fittings 15. The left and right holder metal fittings 15 comprise frame-like members that are formed by bending a bar steel to have an upside-down U shape. As shown in FIG. 8, the holder metal fittings 15 are supported by the extensions 14 of the base 10 so as to be slid in the left-to-right direction. FIG. 8 shows a state where the left and right holder metal fittings 15 are received. As shown in FIG. 29, by pulling the left and right holder metal fittings 15 outward in the left-to-right directions, respectively, the auxiliary fences 82 can be placed (housed) on the upper surface side of the holder metal fittings 15.

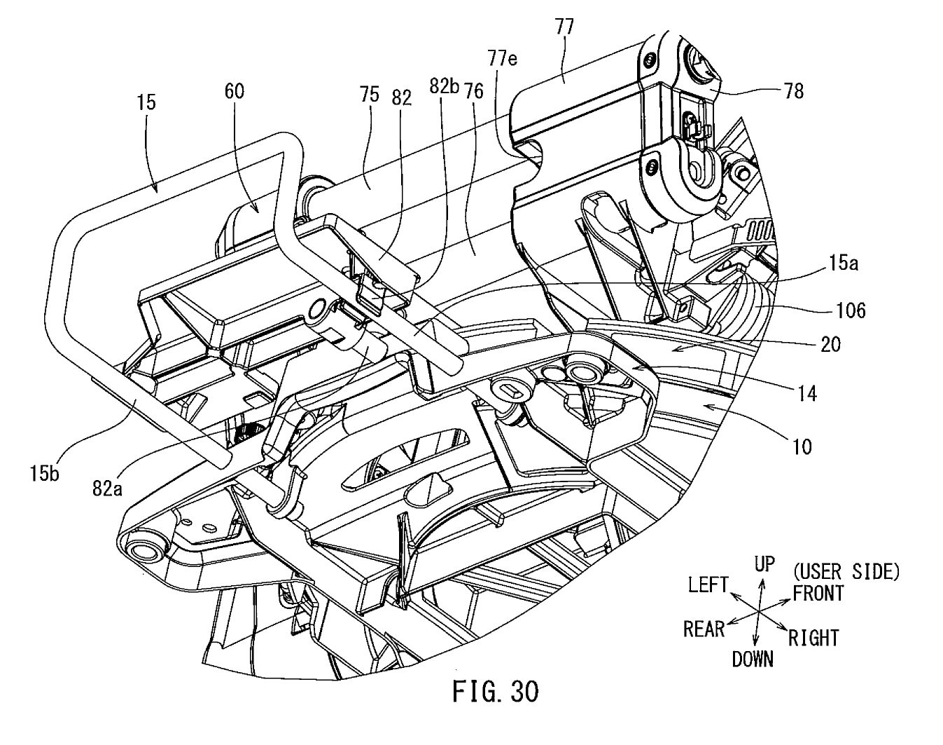

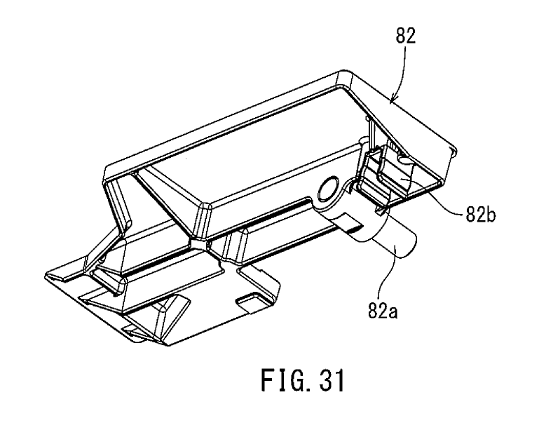

As shown in FIG. 31, the auxiliary fence 82 includes a positioning pin 82a and a grip 82b. The positioning pin 82a is inserted into a positioning hole 81a that is provided in the base portion 81 in order to place the auxiliary fence 82 flush with the base portion 81. When the auxiliary fence 82 is removed from the base portion 81 and housed in the holder metal 15, the grip 82b is used. As shown in FIG. 30, by elastically clasping the grip 82b on a cylindrical rail of the holder metal 15, the auxiliary fence 82 is retained in the holder metal 15. FIG. 30 shows a state where the auxiliary fence 82 is housed by clasping the grip 82b on a front-side supporting cylindrical rail of the holder metal 15. However, if the auxiliary fence 82 is placed in an inverted state in the front-to-rear direction, then it may be housed by retaining the grip 82b on a rear-side cylindrical rail of the holder metal 15.

In prior art such as, for example, Japanese Laid-Open Patent Publication No. 2010-280013, it is not considered where to house the removed auxiliary fence in this type of tabletop cutting device. Because of this circumstance, it will take some time to retrieve the removed auxiliary fence, or if the removed auxiliary fence is lost, the workpiece W has to be positioned under a positioning surface having a low height. As a result, cutting accuracy may be substantially decreased and operability may be impaired. In contrast, however, according to the above-discussed housing configurations of the auxiliary fences of the present embodiment, the auxiliary fences 82 can be housed in the left and right holder metal fittings 15 of the base 10. Thus, it may not be necessary to waste operating time to find the auxiliary fences 82, or there is no fear that the auxiliary fences 82 may be lost. Because of this, operability and ease of use is enhanced.

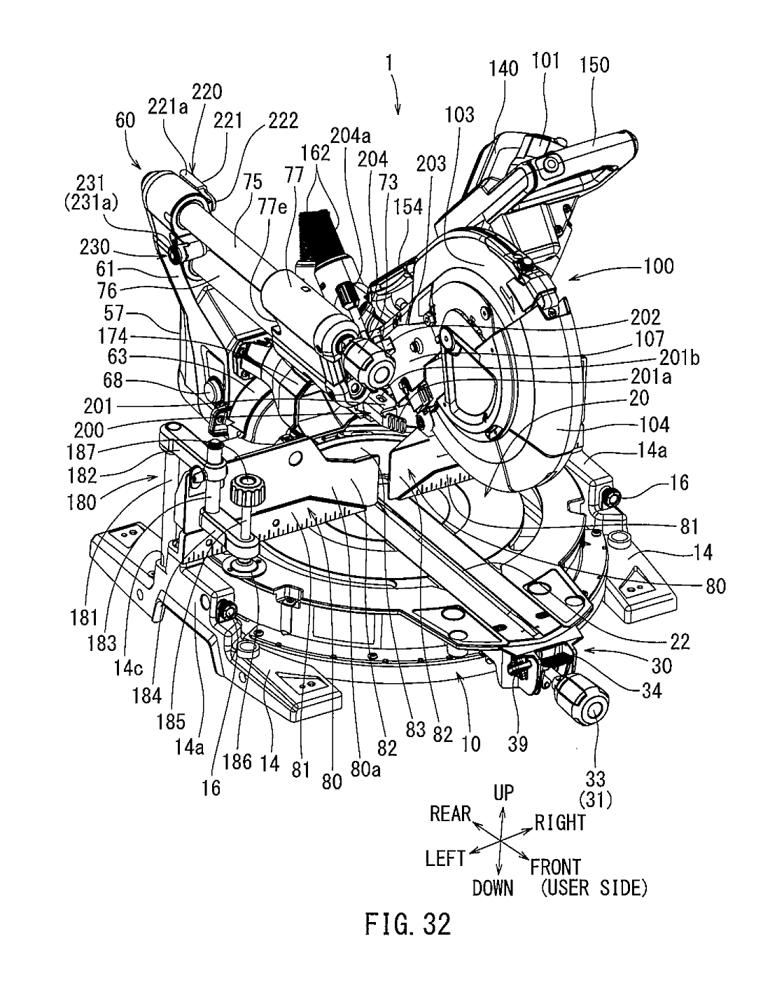

As shown in FIG. 32, a vertical vise 180 for fixing the workpiece W is attached to the left and right extension portions 14 of the base 10. The workpiece W is pressed down toward the upper surface of the table 20 from above by the vertical vise 180 and the workpiece W is held in the up-to-down direction thereof so as to be fixed to the table 20. The vertical vise 180 includes a first support pole 181, a first arm 182 that is joined to an upper portion of the first support pole 181, a second support pole 183 that is supported by a tip end of the first arm 182, a second arm 184 that is joined to a lower portion of the second support pole 183, and a screw shaft 185 that is supported by a tip end of the second arm 184. The first support pole 181 is inserted into a supporting hole 14c that is provided on the rear side of the seat portion 14a so as to be inserted and extracted without rattling. The first support pole 181 is fastened by a fixing screw (not shown in FIG. 32) that is provided at the rear of the seat portion 14a so as to be fixed in the inserted state of the first support pole 181. The first arm 182 is supported so as to be rotatable in the left-to-right direction about the first support pole 181. The second support pole 183 is supported by a tip end portion of the rotatable first arm 182 so as to be adjustable in the up-to-down direction. The second arm 184 is supported so as to be rotatable in the left-to-right direction about the second support pole 183. The screw shaft 185 is fastened to a tip end side of the rotatable second arm 184. Furthermore, a knob 187 that the user holds when pressing the workpiece W downward is provided at an upper end portion of the screw shaft 185. A circular pressing plate 186 that is pressed to the upper surface of the workpiece W is supported at a lower end portion of the screw shaft 185.

When the screw shaft 185 is rotated in the fastening direction while the pressing plate 186 contacts the upper surface of the workpiece W that is placed on the table 20, the pressing plate 185 presses the upper surface of the workpiece W by the screw force and the workpiece W is subsequently firmly affixed downward onto the upper surface of table 20. FIG. 32 shows a state where the left and right auxiliary fences 82 are supported on the upper surface side of the base portions 81 and a positioning surface 80a with substantial height is created. The vertical vise 180 is supported straddling behind the positioning fence 80 as well as in front of the positioning fence 80. In this embodiment, the vertical vise 180 is supported using the supporting hole 14c of the seat portion 14a. Instead, the vertical vise 180 may also be supported using the removed auxiliary fence 82 that is housed in the seat portion 14a, which will be discussed below.

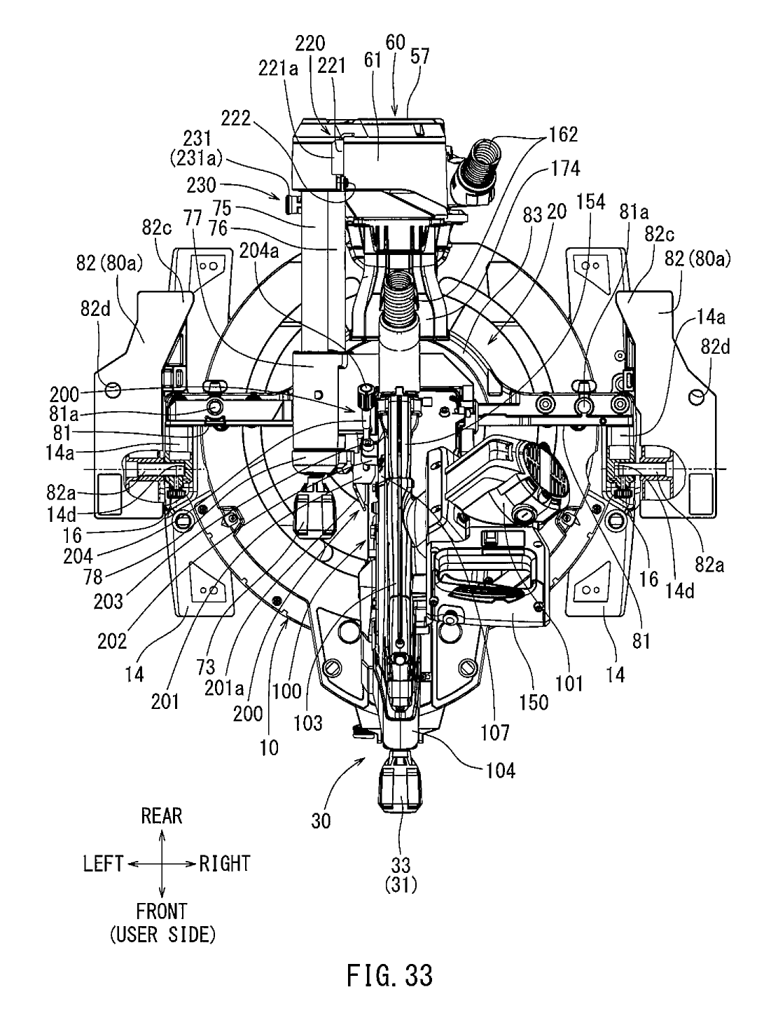

As shown in FIG. 33, the auxiliary fence 82 that is removed from the base portion 81 is retained on the seat portion 14a so as to extend in the left-and right direction of the seat portion 14a by insertion of the positioning pin 82a of the auxiliary fence 82 into a retaining hole 14d that is provided at the lateral portion of the seat portion 14a. The insertion state of the positioning pin 82a with respect to the retaining hole 14d is locked by fastening a fixing screw 16. A rear portion 82c of the auxiliary fence 82 can be retainably placed on the upper surface of extension portion 14. In this way, the positioning surface 80a of the auxiliary fence 82 is retainably placed downwardly flush with the upper surface of the table 20. Because of this configuration, a workpiece W having a wide length in the left-to-right direction is placed on the table 20, and eventually a cutting work of such a workpiece W can be precisely performed.

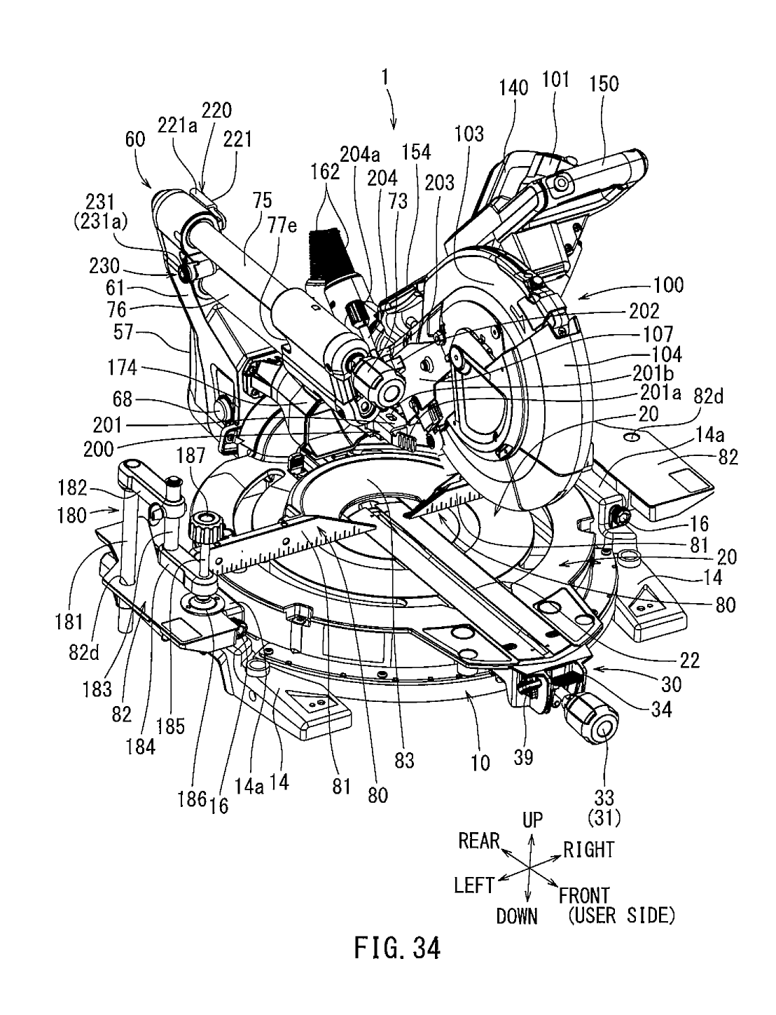

Furthermore, as shown in FIG. 34, the vertical vise 180 may also further be supported using the auxiliary fence 82 that is retained as discussed above. FIG. 34 shows that the vertical vise 180 is supported only on the left side, but it may also be supported on the right side using the auxiliary fence 82 retained on the right-side seat portion 14a in the same manner as described infra. The auxiliary fence 82 is provided with a supporting hole 82d. The vertical vise 180 is supported by inserting the first support post 181 of the vertical vise 180 into the supporting hole 82d. Though this is not shown in FIG. 34, a fixing screw is provided at the immediate rear of the supporting hole 82d. By fastening the fixing screw in the front-to-rear direction, the first support post 181 is fixedly be inserted into the supporting hole 82d. By supporting the vertical vise 180 using the supporting hole 82d of the auxiliary fence 82, the vertical vise 180 is retained in a position to be offset in the leftward direction or in the rightward direction with regard to the seat portion 14a. Because of this configuration, the workpiece W having a large length in the left-to-right direction can still be firmly fixed downward onto the upper surface of table 20.

[Lower Limit Position Changeover Mechanism 200]

The tabletop cutting device 1 according to the present embodiment is provided with a lower limit position change mechanism 200, a swing lock mechanism 210, a slide intermediate stopper mechanism 220, and a slide rear end position lock mechanism 230. The lower limit position change mechanism 200 is a mechanism for changing a lower limit position of the cutting device main body 100 within its swing range in the up-to-down direction. This mechanism 200 includes a function of adjusting or changing a cutting depth of the cutting blade 102 with respect to the workpiece W. As shown in FIGS. 22, 29, 32, and 35, a stopper receiving base is formed integrally with the main body slider 77 at the lower portion thereof. A stopper plate 201 is provided so as to be displaceable in the left-to-right direction on the upper surface of the stopper receiving base. The stopper plate 201 is provided with a knob 201a. The user can pinch the knob 201a and move it in the left-to-right direction (horizontally) between a right-side first position and a left-side second position. When the stopper plate 201 is positioned at the right-side first position, a long-hole shaped relief hole 201b that is provided in the stopper plate 201 and an insertion hole (not shown in the figures) that is provided in the stopper receiving base passing through the base in the up-to-down direction are overlapped. On the other hand, when the stopper plate 201 is positioned at the left-side second position, the relief hole 201b is disposed offset in the leftward direction with respect to the insertion hole of the stopper receiving base. As a result, the insertion hole of the stopper receiving base is blocked by the stopper plate 201.

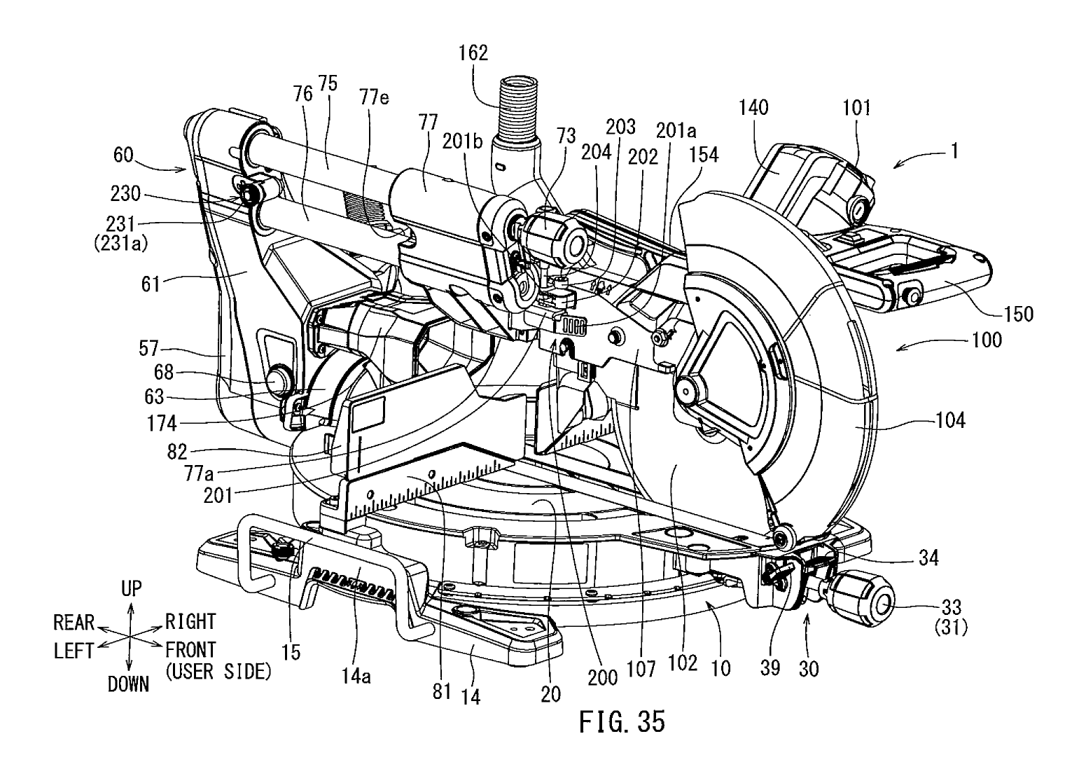

As shown in FIG. 35, a stopper supporting portion 202 is formed integrally with the base 107 on the left side portion of the base 107 of the cutting device main body 100 in the lateral direction. A front-side stopper screw 203 and a rear-side stopper screw 204 are fastened to the stopper supporting portion 202. A knob 204a that the user operates when fastening is provided at the upper portion of the rear-side second stopper screw 204. The lower portions of the stopper screws 203, 204 protrude in the downward direction from the lower surface of the stopper supporting portion 202. The rear-side stopper screw 204 protrudes farther downward vertically than the front-side stopper screw 203 from the lower surface of the stopper supporting portion 202. By rotating the stopper screw 203, 204, respectively, a protruding length thereof from the lower surface of the stopper supporting portion 202 can be adjusted. When the cutting device main body 100 is moved in the downward direction as shown in FIG. 35, the leftward direction or in the rightward direction wit aforementioned relief hole 201b and the insertion hole that are overlapped with each other to be released (idle movement) in a state where the stopper plate 201 is positioned at the right-side first position. In this case, the front-side first stopper screw 203 abuts against the stopper plate 201 and the lower limit position of the cutting device main body 100 is restricted in this manner.

Though not shown in the figures, when the cutting device main body 100 is moved in the downward direction in a state when the stopper plate 201 is moved to the left-side second position, the relief hole 201b is disposed offset in the leftward direction with respect to the insertion hole and thus the rear-side second stopper screw 204 that extends longer than the first stopper screw 203 in the downward direction abuts against the stopper plate 201, which restricts the lower limit position of the cutting device main body 100. According to the above-discussed lower limit position change mechanism 200, by changing between a first state where the stopper plate 201 is positioned to the right-side first position to overlap the relief hole 201b with the insertion hole and a second state where the stopper plate 201 is positioned to the left-side second position offset from the relief hole 201b with respect to the insertion hole, a state where the first stopper screw 203 abuts against the stopper plate 201 and a state where the second stopper screw 204 abuts against the stopper plate 201 can be selected. As a result, the lower limit position of the cutting device main body 100 is changed at the two positions in the up-to-down direction. The lower limit position of the cutting device main body 100 that is restricted by the first stopper screw 203 in a first state is configured to be the lowest possible position that is set according to a positional relationship between the cutting blade 102 and the cutting edge plate 22. When the second state lower limit position that is restricted by the second stopper screw 204, which is disposed at a position relatively higher than the position restricted by the first stopper screw 203, for example, a groove cutting can be rapidly performed. These two lower limit positions in the up-to-down direction can be separately adjusted by rotating the first stopper screw 203 and the second stopper screw 204 and adjusting fastening amounts with respect to the stopper supporting portion 202, respectively.

[Swing Lock Mechanism 210]

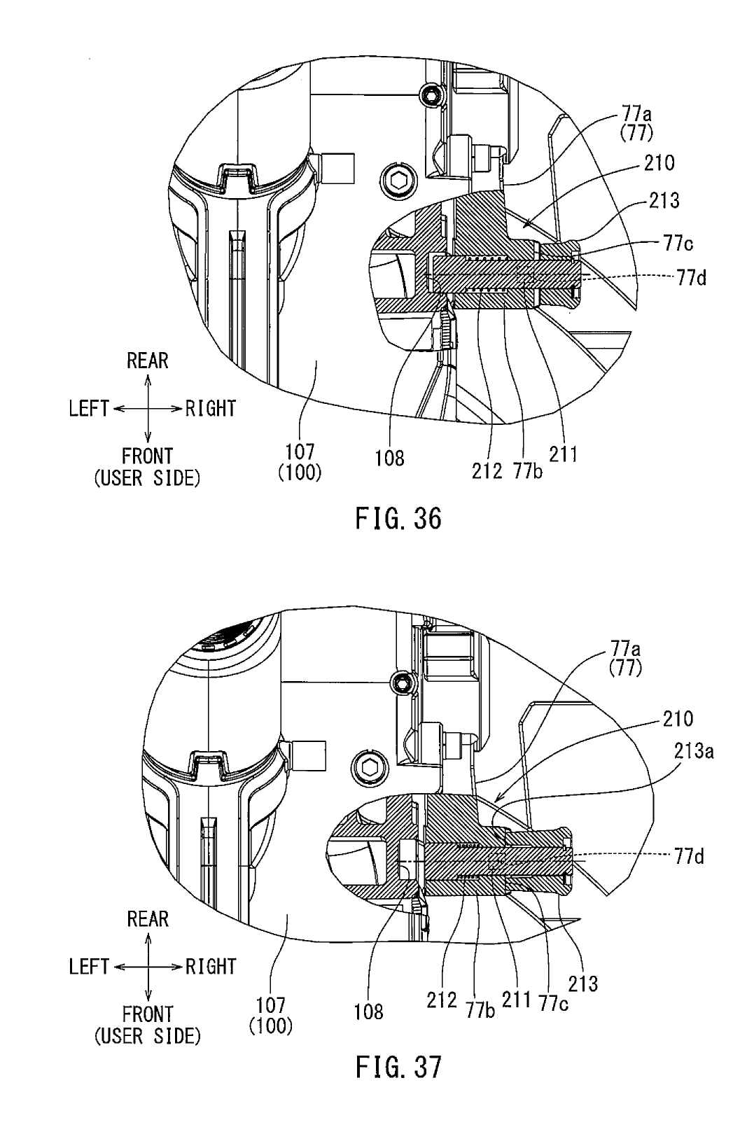

The lower limit position of the cutting device main body 100 is restricted by the swing lock mechanism 210 as well as the above discussed first stopper screw 203 and second stopper screw 204. By the swing lock mechanism 210, the cutting device main body 100 can be restricted to a locked position after the cutting device main body 100 is swung in the downward direction as shown in FIG. 35. FIGS. 36 and 37 show a detail of the swing lock mechanism 210. The swing lock mechanism 210 is provided on the main body supporting portion 77a of the main body slider 77. A supporting tube 77b is provided on the right side tip end of the main body supporting portion 77a. A lock pin 211 is provided inside the inner peripheral circumferential surface of the supporting tube 77b so as to be rotatable about its longitudinal axis and displaceable in the left-to-right direction. The lock pin 211 is biased to move in the leftward direction (lock side) by a compression spring 212 that is interposed between the supporting tube 77b and the lock pin 211. A knob 213 that the user pinches when operating is attached to a right tip end (head portion) of the lock pin 211. An engagement protrusion 213a is provided on a left end portion of the knob 213 along an axial direction.

A shallow groove 77c and a deep groove 77d that are orthogonally crossed to each other are provided on the right end portion of the supporting tube 77b. When the knob 213 is rotated and the engagement protrusion 213a is inserted into the shallow engagement groove 77c as shown in FIG. 37, the lock pin 211 is displaced in the rightward direction and retained at an unlock position. When the knob 213 is rotated by approximately 90° from the unlock position and the engagement protrusion 213a is inserted into the deep groove 77d, the lock pin 211 can be displaced to the left-side lock position.

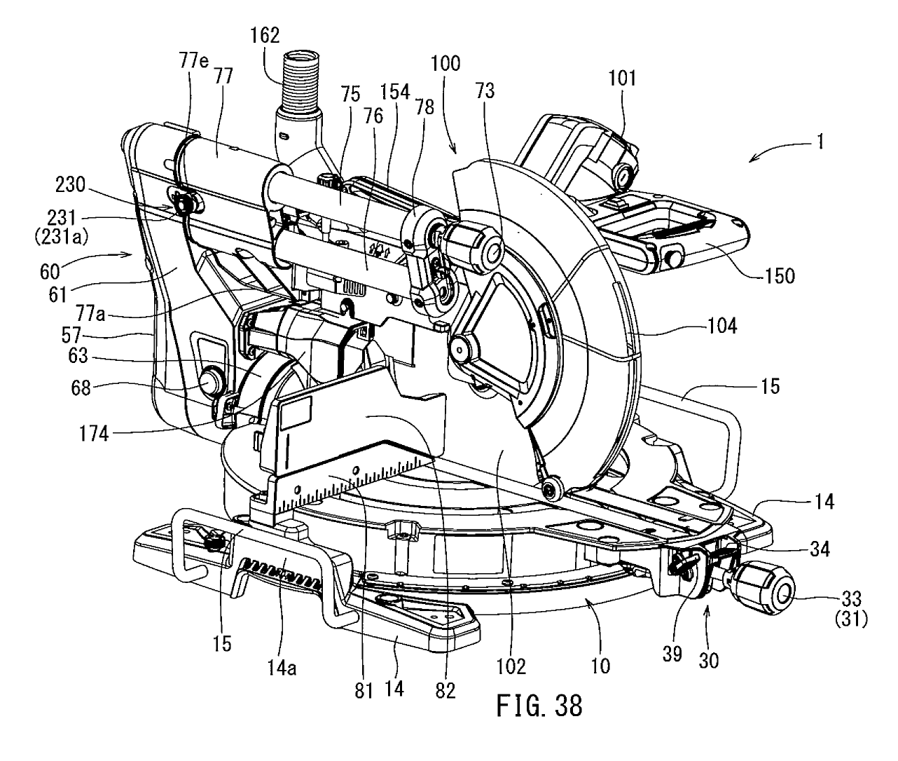

A lock hole 108 is provided on the right side of the base 107 of the cutting device main body 100. The lock hole 108 is also shown in FIG. 5. When the cutting device main body 100 is swung in the downward lock position and the lock pin 211 is displaced to the leftward lock position, the tip end of the lock pin 211 is inserted into the lock hole 108. By inserting the lock pin 211 into the lock hole 108, the cutting device main body 100 is locked to the downward lock position. As discussed earlier, in a state where the cutting device main body 100 is locked in the lock position, the carrying handle 154 is approximately horizontally positioned. By locking the cutting device main body 100 to the downward lock position by use of the swing lock mechanism 210 as shown in FIG. 38 and by also locking the cutting device main body 100 to a slide rear end position by use of the slide rear end position lock mechanism 230, which is discussed infra, the user can hold the carrying handle 154 and easily carry the tabletop cutting device 1 in a well-balanced manner.

[Slide Intermediate Stopper Mechanism 220]

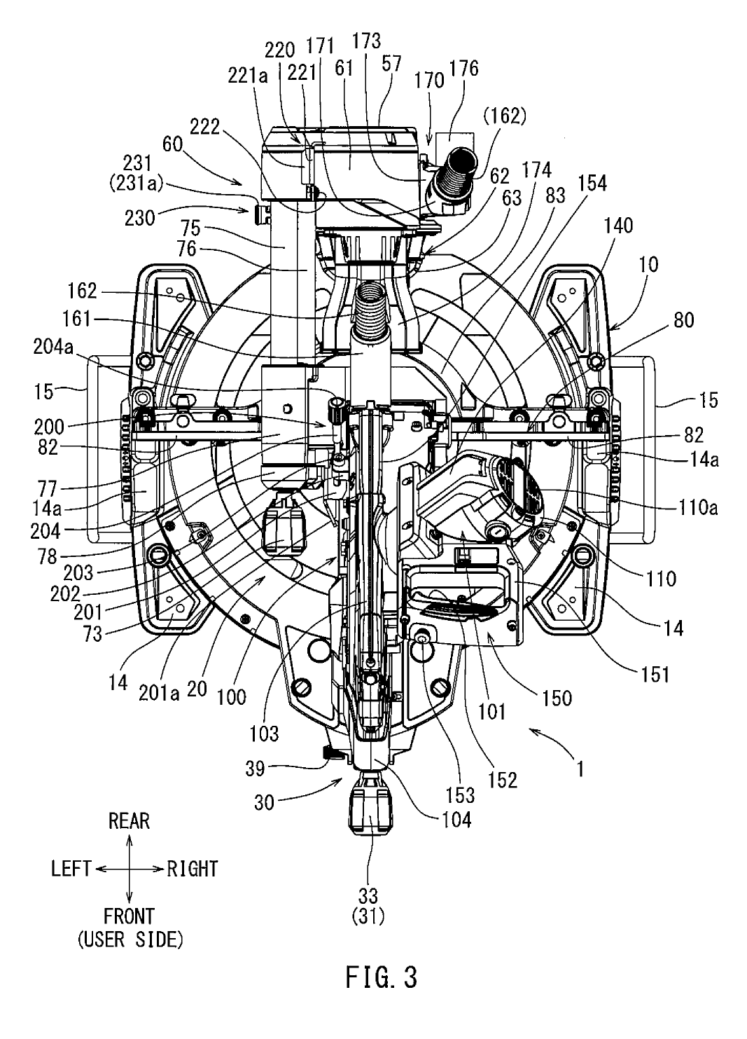

As shown in FIGS. 3, 5, 32 to 34, the slide intermediate stopper mechanism 220 is provided on the upper right side of the main body supporting portion 60. The slide intermediate stopper mechanism 220 is configured such that a stopper plate 221 is supported so as to be rotatable in the up-to-down direction via a support shaft 222. Furthermore, the stopper plate 221 is bent at the upper periphery to form a stopper portion 221a which extends in the leftward direction as shown in, for example, FIG. 32. By rotating the stopper plate 221 around a support shaft 222 in the forward direction as indicated by the void arrow of FIG. 5 from a retracted position (as shown in the figures), in which the stopper plate 221 is initially disposed along the right side portion of the main body supporting portion 60, the stopper plate 221 is then displaced post-rotation to a stopper position (not shown in the figures) in which the stopper plate 221 extends in the forward direction along a lateral side (right side) of the upper slide bar 75. When the stopper plate 221 is displaced to said stopper position, the stopper portion 221a is positioned in (entered) the front-to-rear moving path of the main body slider 77. Because of this configuration, when the cutting device main body 100 is slid in the rearward direction, in a state where the stopper plate 221 is already present in the stopper position, then a rear end surface of the main body slider 77 contacts and abuts the stopper portion 221a, thus inhibiting a further rearward slide movement of the cutting device main body 100.

When the stopper plate 221 is positioned in the retracted position, the main body slider 77 can slide to a position where the rear end surface of the main body slider 77 contacts the front surface of the main body supporting portion 60 (entire slide range). When the stopper plate 221 is displaced to the front-side stopper position, however, a maximal rear end position of the main body slider 77 within a slidable range is cut short by the length of the stopper portion 221a. Because of this configuration, by restricting the slide rearward (retracted) end position of the main body slider 77 by use of the slide intermediate stopper mechanism 220, for example, when the workpiece W such as a so-called crown-shaped molding material is obliquely leaned to the positioning fence 80 to perform a cutting work, a slide movement of the cutting device main body 100 can be restricted before the members, such as the outer flange 131, the inner flange 132, and the head of the cutting blade fixing screw 134 by which the cutting blade 102 is attached, interfere with the workpiece W. As a result, damage to the workpiece itself can be prevented.

[Slide Rear End Position Lock Mechanism 230]

The cutting device main body 100 can be locked at a rearward (retracted) end position (slide rear end position) of the entire slide range by use of the slide rear end position lock mechanism 230. The slide rear end position lock mechanism 230 is provided on the upper left side of the main body supporting portion 60. The slide rear end position lock mechanism 230 is provided with a lock pin 231 with a knob 231a that is spring-biased toward a lock direction, which is similar to the above-discussed swing lock mechanism 210. A relief recess 77e for receiving the slide rear end position lock mechanism 230 is provided on the upper left side of the main body slider 77. As shown in FIG. 2, a lock hole 77f is provided at the bottom of the relief recess 77e. As shown in FIG. 38, by sliding the main body slider 77 to the slide rear end position and inserting the lock pin 231 into the lock hole 77f, the main body slider 77 and eventually the cutting device main body 100 is locked to the slide rear end position. By pinching the knob 231 and rotating the lock pin 231 90° to move the lock pin 231 to the unlock position against the spring biasing force, the lock pin 231 can then be retained at the unlock position. In this state, the main body slider 77 and eventually the cutting device main body 100 can be freely slid in the front-to-rear direction.

According to the tabletop cutting device 1 according to the present embodiment configured as described above, when the operation knob 73 is rotated, the spring biased engagement pin 58 (click mechanism) of the inclination fixing mechanism 50 provides a click feeling (feeling of moderation). Because of this configuration, the user can recognize a fixing state of the cutting device main body 100 at the inclination position in a sensible manner, by obtaining the click feeling with his/her hand while rotating the operation knob 73. In this respect, operability of the operation knob 73 and eventually of the inclination fixing mechanism 50 can be improved.

Furthermore, by obtaining the click feeling while rotating the operation knob 73, the user can prevent excessively tight fastening of the first pulley 51 with respect to the screw shaft portion 65a of the left/right inclination shaft 65. In this respect, operability of the inclination fixing mechanism 50 can be improved.

Furthermore, the click feeling can be obtained by the configuration in which the engagement pin 58 is elastically engaged with the second pulley 54 that is located at an upstream side of the transmission belt 55 with respect to the power transmission path of the operation knob 73. Also, the operation knob 73 is directly joined to the second pulley 54 via the transmission rod 79. Because of this configuration, the user can recognize the click feeling transmitted to the second pulley 54 directly with his/her hand by which the user holds the operation knob 73. In this respect, operability of the operation knob 73 can be further improved. If a click mechanism were to be provided in the first pulley 51 located at a downstream side of the transmission belt 55, the click feeling may not be transmitted to the operation knob 73 in a sufficiently strong manner, owing to flexure of the transmission belt 55, etc. Accordingly, operability may be decreased, in comparison with the configuration described above.

Furthermore, the operation knob 73 is rotatably supported at the front portion of the slide bar 75 that supports the cutting device main body 100 so as to be slidable in the front-to-rear direction. The transmission rod 79 is rotatably supported in the inner circumference of the slide bar 75. The operation knob 73 and the transmission rod 79 are supported by the slide bar 75. Because of this configuration, the number of components can be reduced, in comparison to the case where the operation knob 73 and the transmission rod 79 are supported by dedicated components that are separately provided. Furthermore, the flange 54a is provided integrally with the second pulley 54, and the engagement recesses 54b used for providing the click feeling are located on the flange 54. Because of this configuration, a number of components can be reduced, in comparison with a case where the engagement recesses are provided by utilizing another components separately provided.

Furthermore, according to the exemplified inclination fixing mechanism 50, the belt pressing portion 57a, which presses the transmission belt 55 from the outward facing side thereof, is provided integrally with the arm cover 57. Because of the presence of the belt pressing portion 57a, an engagement state of the transmission belt 55 with respect to mainly the second pulley 54 can be maintained. Because of this configuration, for example, if an abrupt and rapid rotation of the operation knob 73 in the fastening direction causes a fastening torque to be rapidly applied to the second pulley 54, the belt pressing portion 57a can help maintain the engagement of the transmission belt 55 with the second pulley 54. As a result, the operation power of the operation knob 73 can be adequately transmitted to the left/right inclination shaft 65, and thus the inclination position of the cutting device main body 100 can be fixed. Some may consider a countermeasure against tooth skipping of a so-called timing belt (toothed belt) includes increased diameter of the pulley or increased width of the belt. However, this countermeasure may cause an increase in the size of the device. The belt pressing portion 57a as exemplified above can help solve the problem of tooth skipping of the belt without causing an increase in the size of the device.

The belt pressing portion 57a is arranged to the front side of the fastening rotation direction of the left/right inclination shaft 65 with respect to the second pulley 54. When the operation knob 73 is rotated in the fastening direction, a lift of the transmission belt 55 may easily occur to the front side of the rotation direction of the second pulley 54. However, the lift can be restricted by the presence of the belt pressing portion 57a.

Furthermore, the belt pressing portion 57a is arranged as close to the second pulley 54 as possible. Because of this configuration, the lift of the transmission belt 55 from the second pulley 54 can be effectively restricted, which prevents disengagement of the belt in a sufficient manner.

The embodiments discussed above may be further modified in various ways. For example, apart from the configuration in which the belt pressing portion 57a is arranged at one place as discussed above, the belt pressing portion 57a can be arranged at a plurality of places. Because of this arrangement, the lift of the transmission belt 55 from the first pulley 51 and the second pulley 54 can be restricted in a more sufficient manner. As a result, the operation power of the operation knob 73 can be transmitted to the left/right inclination shaft 65 in a more sufficient manner.

Furthermore, in the above-exemplified embodiment, the belt pressing portion 57a is formed integrally with the arm cover 57 made from synthetic resin. However, a configuration may be adopted in which a belt pressing portion 57a is provided separately from the arm cover 57 and is attached to the arm cover 57 by a screw, etc. Furthermore, another configuration may be adopted in which a belt pressing portion 57a is formed integrally with the main body supporting arm 61. Still another configuration may be adopted in which a resin-made belt pressing portion is separately provided and is attached to the arm cover 57 by using an adhesive agent, etc.

In the above-exemplified embodiment, the inclination fixing mechanism 50 is configured such that the left/right inclination shaft 65 is remotely operated by the operation knob 73 via a belt transmission mechanism. However, the above-exemplified click mechanism can be applied to another configuration in which an operation knob 73 is directly attached to the left/right inclination shaft 65 and the left/right inclination shaft 65 is directly fastened at the rear surface side of the main body supporting portion 60.

The belt pressing portion 57a that is formed integrally with the arm cover 57 may be omitted. Instead of the belt pressing portion 57a, the idler 56 may be arranged at a plurality of places.

Furthermore, the above-exemplified tabletop cutting device 1 is operated by the mains power. However, the present teaching can be applied to a battery-powered tabletop cutting device operated by a rechargeable battery.

### A Click Mechanism Arranged Around the Second Pulley 241 (A Second Embodiment)

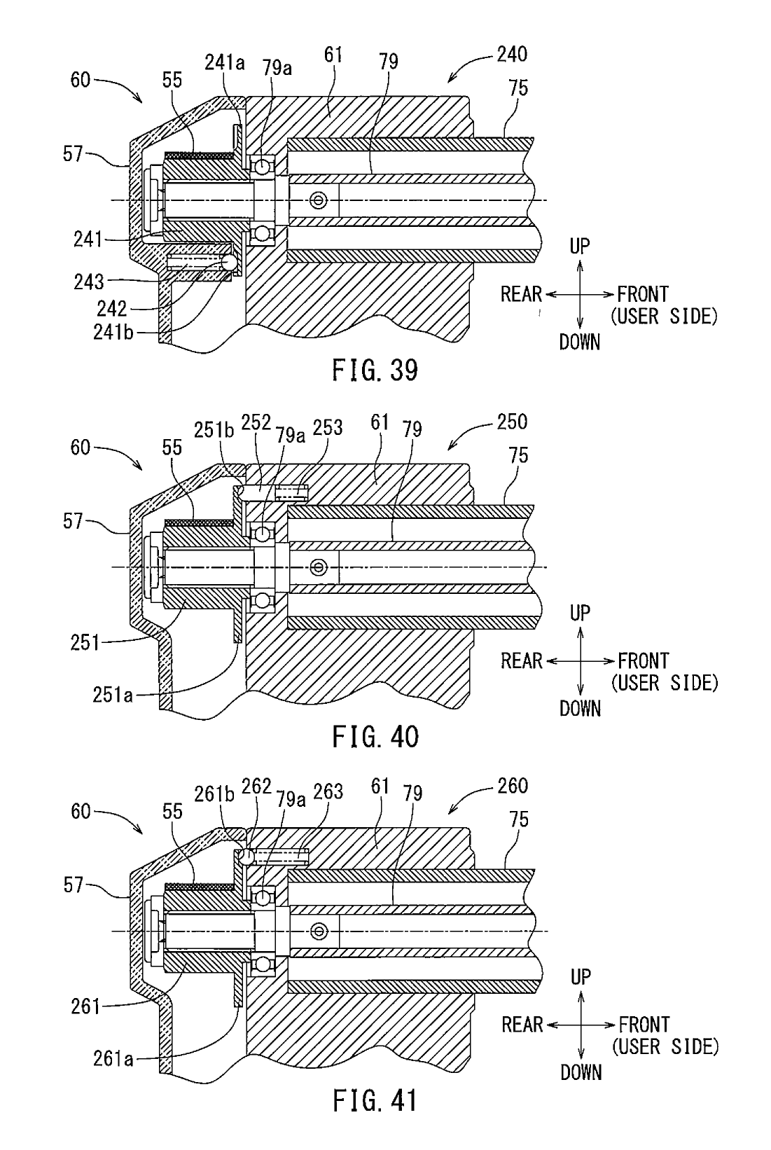

A tabletop cutting device 240 may have a click mechanism shown in FIG. 39, instead of the click mechanism shown in FIG. 21. The click mechanism in FIG. 39 includes a second pulley 241 that is formed in the same way as the second pulley 54 shown in FIG. 21. The second pulley 241 includes a flange 241a. A plurality of engagement recesses 241b are provided within the rear surface of the flange 241a. The plurality of engagement recesses 241b are arranged at equally spaced radial intervals along a concentric circle having its radial center coinciding with a rotational center of the second pulley 241.

The click mechanism in FIG. 39 includes an engagement ball 242 and a compression spring 243, instead of the engagement pin 58 and the compression spring 59 shown in FIG. 21. The engagement ball 242 and the compression spring 243 are housed in a recess provided at the upper portion of the arm cover 57. The recess is open towards the flange 241a. The engagement ball 242 is located at the lower portion of the second pulley 241 and at the rearward portion of the flange 241a. The engagement ball 242 is biased in a protruding direction by the compression spring 243, i.e. in the forward direction. The forward biased engagement ball 242 is elastically pressed so as to enter into the engagement recess 241b.

By rotation of the operation knob 73 shown in FIG. 2, the second pulley 241 shown in FIG. 39 is rotated in the rotation direction and the engagement ball 242 enters the engagement recesses 241b arranged in the circumferential direction in a sequential manner. Because of this configuration, the second pulley 241 can be positioned at a predetermined angular interval, along with the click feeling being produced.

### A Click Mechanism Arranged Around the Second Pulley 251 (A Third Embodiment)

A tabletop cutting device 250 may have a click mechanism shown in FIG. 40, instead of the click mechanism shown in FIG. 21. The click mechanism in FIG. 40 includes a second pulley 251, instead of the second pulley 54 shown in FIG. 21. The second pulley 251 includes a flange 251a. A plurality of engagement recesses 251b are provided within the front surface of the flange 251a. The plurality of engagement recesses 251b are arranged at equally spaced radial intervals along a concentric circle having its radial center coinciding with a rotational center of the second pulley 251.

The click mechanism in FIG. 40 includes an engagement pin 252 and a compression spring 253, instead of the engagement pin 58 and the compression spring 59 shown in FIG. 21. As shown in FIG. 40, the engagement pin 252 and the compression spring 253 are housed in a recess provided at a rear end portion of the main body supporting arm 61. The recess is open towards the flange 251a. The engagement pin 252 is located above the bearing 79a and in front of the flange 251a. The engagement pin 252 is biased in a protruding direction by the compression spring 253, i.e. in the rearward direction. The rearward biased engagement pin 252 is elastically pressed so as to enter into the engagement recess 251b. Because of this configuration, the second pulley 251 can be positioned at a predetermined angular interval, with the click feeling being produced when the second pulley 251 is rotated in the rotation direction. A rotation power transmission mechanism via the second pulley 251 is the same as that of the second pulley 54 referred to FIGS. 20 and 21.

### A Click Mechanism Arranged Around the Second Pulley 261 (A Fourth Embodiment)

A tabletop cutting device 260 may include a click mechanism shown in FIG. 41, instead of the click mechanism shown in FIG. 40. The click mechanism in FIG. 41 includes a second pulley 261 that is formed in the same way as the second pulley 251 shown in FIG. 40. The second pulley 261 includes a flange 261a. A plurality of engagement recesses 261b are provided within the front surface of the flange 261a. The plurality of engagement recesses 261b are arranged at equally spaced radial intervals along a concentric circle having its radial center coinciding with a rotational center of the second pulley 261.

The click mechanism in FIG. 41 includes an engagement ball 262 and a compression spring 263, instead of the engagement pin 252 and the compression spring 253 shown in FIG. 40. The engagement ball 262 and the compression spring 263 are housed in a recess provided at a rear end portion of the main body supporting arm 61. The recess is open towards the flange 261a. The engagement ball 262 is located above the bearing 79a and in front of the flange 261a. The engagement ball 262 is biased in a protruding direction by the compression spring 263, i.e. in the rearward direction. The rearward biased engagement ball 262 is elastically pressed so as to enter into the engagement recess 261b. Because of this configuration, the second pulley 261 can be positioned at a predetermined angular interval, with the click feeling being produced when the second pulley 261 is rotated in the rotation direction.

### A Click Mechanism Arranged Perpendicular to the Second Pulley 271 (A Fifth Embodiment)

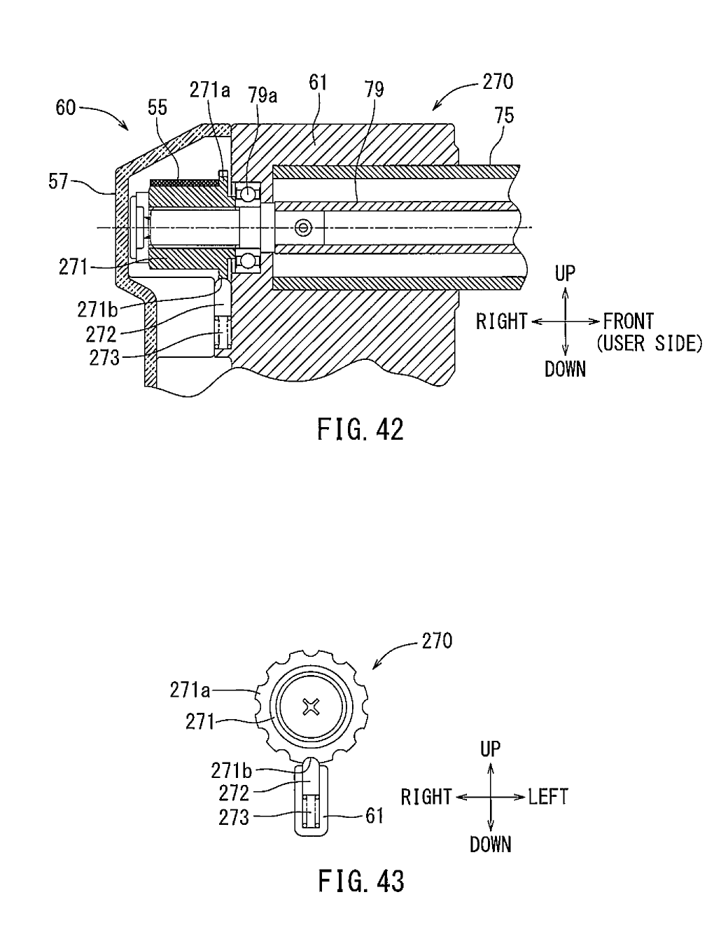

A tabletop cutting device 270 may include a click mechanism shown in FIGS. 42 and 43, instead of the click mechanism shown in FIG. 21. The click mechanism in FIGS. 42 and 43 includes a second pulley 271, instead of the second pulley 54 shown in FIG. 21. The second pulley 271 includes a flange 271a. A plurality of engagement recesses 271b are provided within the outer circumferential surface of the flange 271a. The plurality of engagement recesses 271b are arranged at equally spaced radial intervals along a concentric circle having its radial center coinciding with a rotational center of the second pulley 271.

The click mechanism in FIGS. 42 and 43 includes an engagement pin 272 and a compression spring 273, instead of the engagement pin 58 and the compression spring 59 shown in FIG. 21. As shown in FIGS. 41 and 43, the engagement pin 272 and the compression spring 273 are housed in a recess provided at a rear end portion of the main body supporting arm 61. The recess is located outside the flange 271a in the radial direction (for example, below the flange 271a), and the recess is open towards the flange 271a. The engagement pin 272 is located below the flange 271a and is biased in a protruding direction by the compression spring 273, i.e. in the upward direction. The upwardly biased engagement pin 272 is elastically pressed so as to enter the engagement recess 271b. Because of this configuration, the second pulley 271 can be positioned at a predetermined angular interval, with the click feeling being produced when the second pulley 271 is rotated in the rotation direction.

### A Click Mechanism Arranged Perpendicular to the Second Pulley 281 (A Sixth Embodiment)

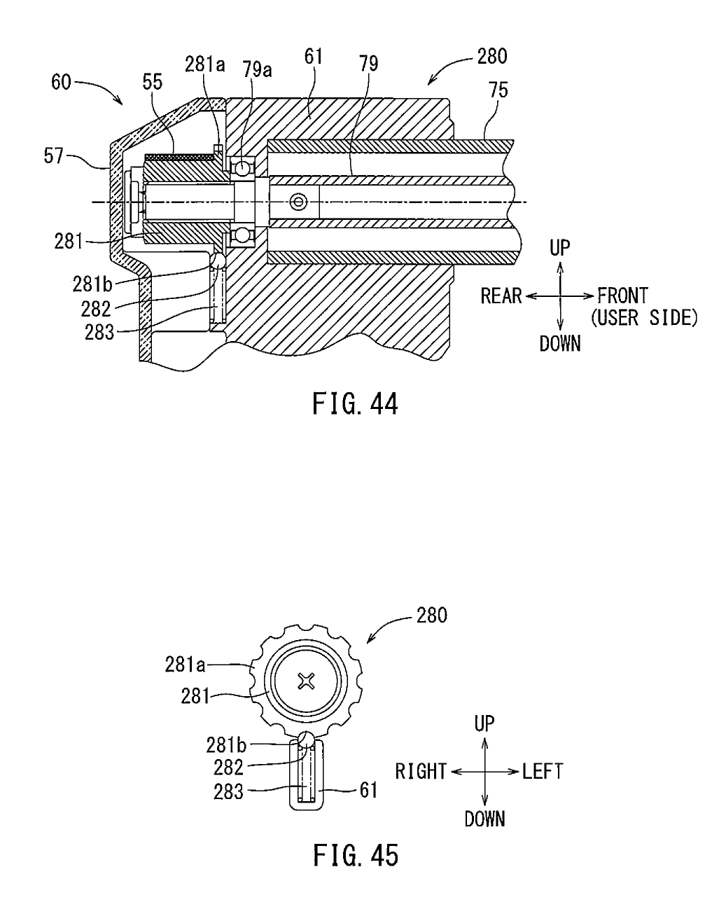

A tabletop cutting device 280 may include a click mechanism shown in FIGS. 44 and 45, instead of the click mechanism shown in FIGS. 42 and 43. The click mechanism in FIG. 44 includes a second pulley 281 that is formed in the same way as the second pulley 271 shown in FIG. 42. The second pulley 281 includes a flange 281a. A plurality of engagement recesses 281b are provided within the outer circumferential surface of the flange 281a. The plurality of engagement recesses 281b are arranged at equally spaced radial intervals along a concentric circle having its radial center coinciding with a rotational center of the second pulley 281.

The click mechanism in FIGS. 44 and 45 includes an engagement ball 282 and a compression spring 283, instead of the engagement pin 272 and the compression spring 283 shown in FIGS. 42 and 43. The engagement ball 282 and the compression spring 283 are housed in a recess provided at a rear end portion of the main body supporting arm 61. The recess is open towards the flange 281a. The engagement ball 282 is located below the flange 281a and biased in a protruding direction by the compression spring 283, i.e. in the upward direction. The upwardly biased engagement ball 282 is elastically pressed so as to enter the engagement recess 281b. Because of this configuration, the second pulley 281 can be positioned at a predetermined angular interval, with the click feeling being produced when the second pulley 281 is rotated in the rotation direction.

### A Click Mechanism Arranged Outside the Second Pulley 291 in the Radial Direction (A Seventh Embodiment)

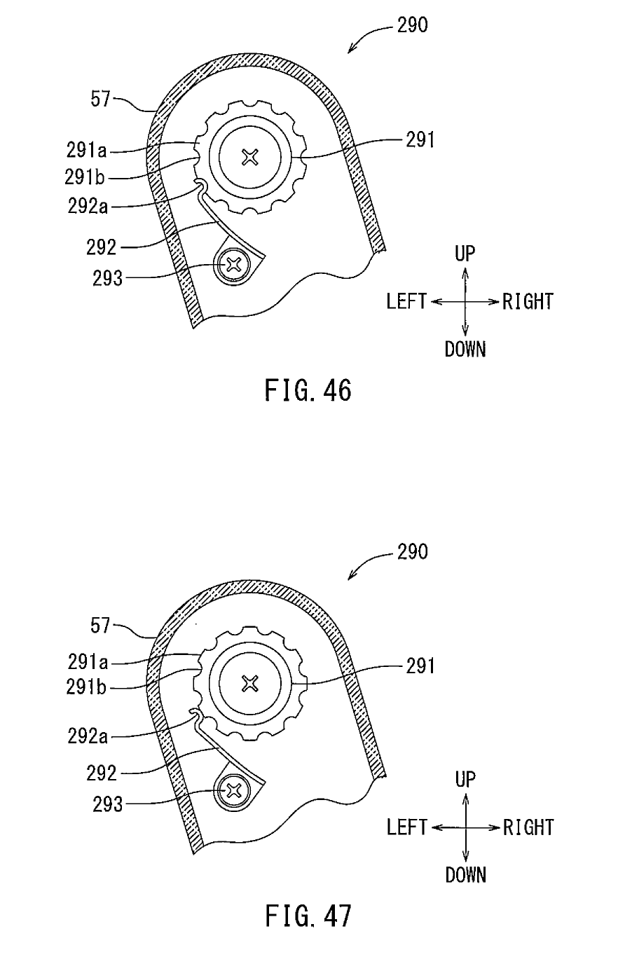

A tabletop cutting device 290 may include a click mechanism shown in FIGS. 46 and 47, instead of the click mechanism shown in FIGS. 42 and 43. The click mechanism in FIGS. 46 and 47 includes a second pulley 291 that is formed in the same way as the second pulley 271 shown in FIGS. 42 and 43. The second pulley 291 includes a flange 291. A plurality of engagement recesses 291b are provided within the outer circumferential surface of the flange 291a. The plurality of engagement recesses 291b are arranged at equally spaced radial intervals along a concentric circle having its radial center coinciding with a rotational center of the second pulley 291.

The click mechanism in FIGS. 46 and 47 includes a leaf spring 292, instead of the engagement pin 271 and the compression spring 273 shown in FIGS. 42 and 43. The leaf spring 292 is provided outside the flange 291a in the radial direction at the upper portion of the arm cover 57. A base end of the leaf spring 292 is attached to the arm cover 57 using a locking screw 293. Alternatively, the base end of the leaf spring 292 may be attached to the main body supporting arm 61 using the locking screw 293. The leaf spring 292 is in a shape of a cantilever beam and elastically deformed such that a tip end thereof is rotated around the base end. A curved engagement portion 292a, that can be engaged with the engagement recess 291b, is formed at the tip end of the leaf spring 292.

As shown in FIGS. 46 and 47, the engagement portion 292a is biased towards a radial center of the flange 291a. The biased engagement portion 292a can be positioned to engage the engagement recess 291b (as shown in FIG. 46) in a more stable manner than in a case where it is pressed to the outer circumferential edge of the flange 291a (as shown in FIG. 47). Because of this configuration, the second pulley 291 can be positioned at a predetermined angular interval, with the click feeling being produced when the second pulley 291 is rotated in the rotation direction.

### A Click Mechanism Arranged Around the Second Pulley 301 (A Eighth Embodiment)

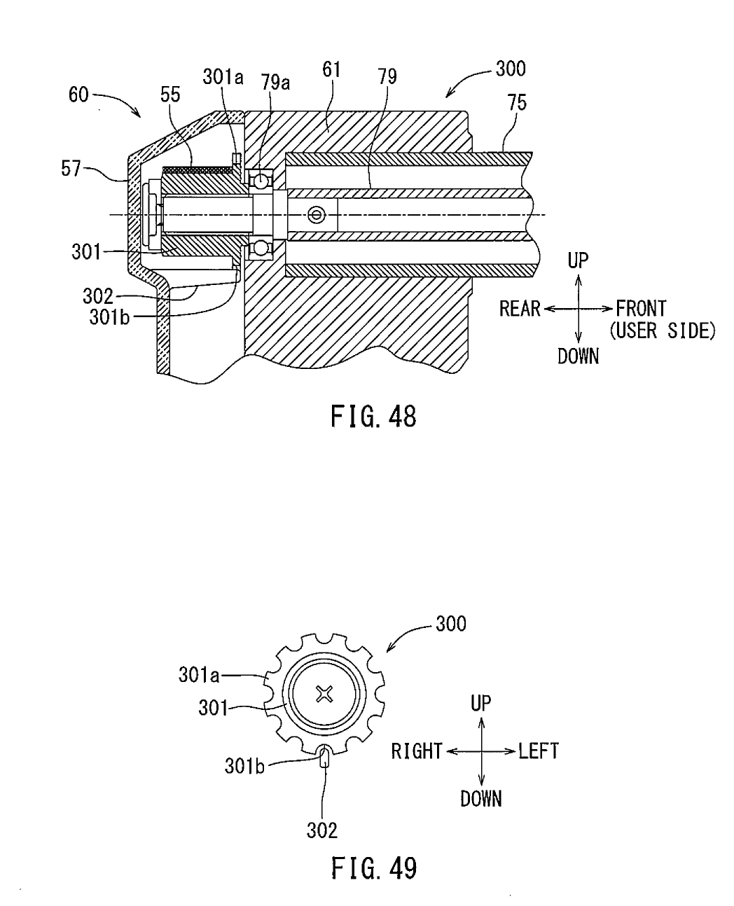

A tabletop cutting device 300 may include a click mechanism shown in FIGS. 48 and 49, instead of the click mechanism shown in FIGS. 46 and 47. The click mechanism in FIGS. 48 and 49 includes a second pulley 301 that is formed in the same way as the second pulley 291 shown in FIGS. 46 and 47. The second pulley 301 includes a flange 301a. A plurality of engagement recesses 301b are provided within the outer circumferential surface of the flange 301a. The plurality of engagement recesses 301b are arranged at equally spaced radial intervals along a concentric circle having its radial center coinciding with a rotational center of the second pulley 301.

The click mechanism in FIGS. 48 and 49 includes a resin spring 302, instead of the leaf spring 292 shown in FIGS. 46 and 47. The resin spring 302 is provided at the upper portion of the arm cover 57, at a distance apart from the flange 301a in its axial direction. The resin spring 302 is located below the second pulley 301, and extends from the arm cover 57 in the forward direction along the axial direction of the second pulley 301. A front end of the resin spring 302 engages with the engagement recess 301b. Furthermore, the front end of the resin spring 302 is elastically pressed such that it enters the engagement recess 301b toward the radial center of the flange 301a. Because of this configuration, the second pulley 301 can be positioned at a predetermined angular interval, with the click feeling being produced when the second pulley 301 is rotated in the rotation direction.

### A Click Mechanism Arranged Perpendicular to the Second Pulley 311 (A Ninth Embodiment)

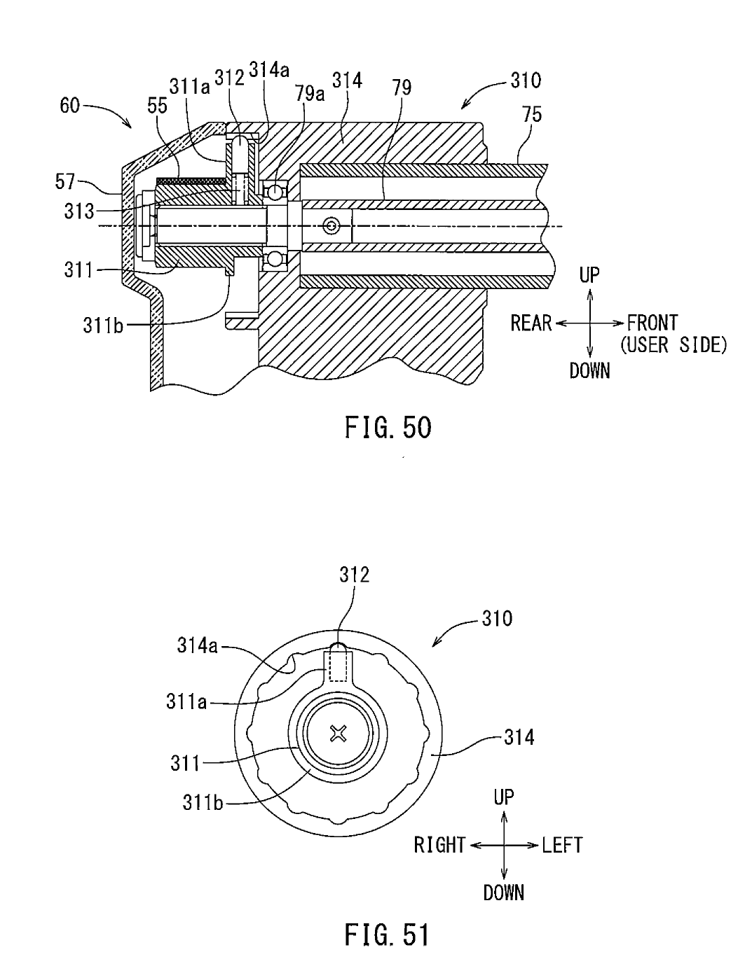

A tabletop cutting device 310 may include a click mechanism shown in FIGS. 50 and 51, instead of the click mechanism shown in FIG. 21. The click mechanism in FIGS. 50 and 51 includes a second pulley 311, an engagement pin 312, and a compression spring 313; instead of the second pulley 54, the engagement pin 58, and the compression spring 59 shown in FIG. 21. The second pulley 311 includes a flange 311b and a pin supporting portion 311a that protrudes from the flange 311b in an outwardly radial direction. The pin supporting portion 311a includes a hole that extends in the radial direction of the second pulley 311. The engagement pin 312 and the compression spring 313 are housed in the hole. The engagement pin 312 is biased by the compression spring 313 in the outwardly protruding direction, i.e. outward in the radial direction of the second pulley 311.

As shown in FIGS. 50 and 51, a tubular portion formed in a substantially cylindrical shape is provided at the rear end portion of the main body supporting arm 314. A plurality of engagement recesses 314a are arranged within the inner circumference surface of the tubular portion. The plurality of engagement recess 314a are arranged at equally spaced radial intervals along a concentric circle having its radial center coinciding with a rotational center of the second pulley 311. The pin supporting portion 311a is provided in the second pulley 311 such that the engagement pin 312 can engage the engagement recess 314a. The engagement pin 312, which is outwardly biased in the radial direction of the second pulley 311, is elastically pressed so as to enter the engagement recess 314a. Because of this configuration, the second pulley 311 can be positioned at a predetermined angular interval, with the click feeling being produced when the second pulley 311 is rotated in the rotation direction.

As shown in FIGS. 50 and 51, an angle formed between the end portion of the engagement recess 314a and the inner circumference surface of the main body supporting arm 314 may be configured to be smaller than, for example, an angle formed between the end portion of the engagement recess 271b and the outer circumference surface of the flange 271a shown in FIG. 43. Because of this configuration, the user may obtain a less non-smooth feeling when rotating the operation knob 73.

### A Click Mechanism Arranged Perpendicular to the Second Pulley 321 (A Tenth Embodiment)

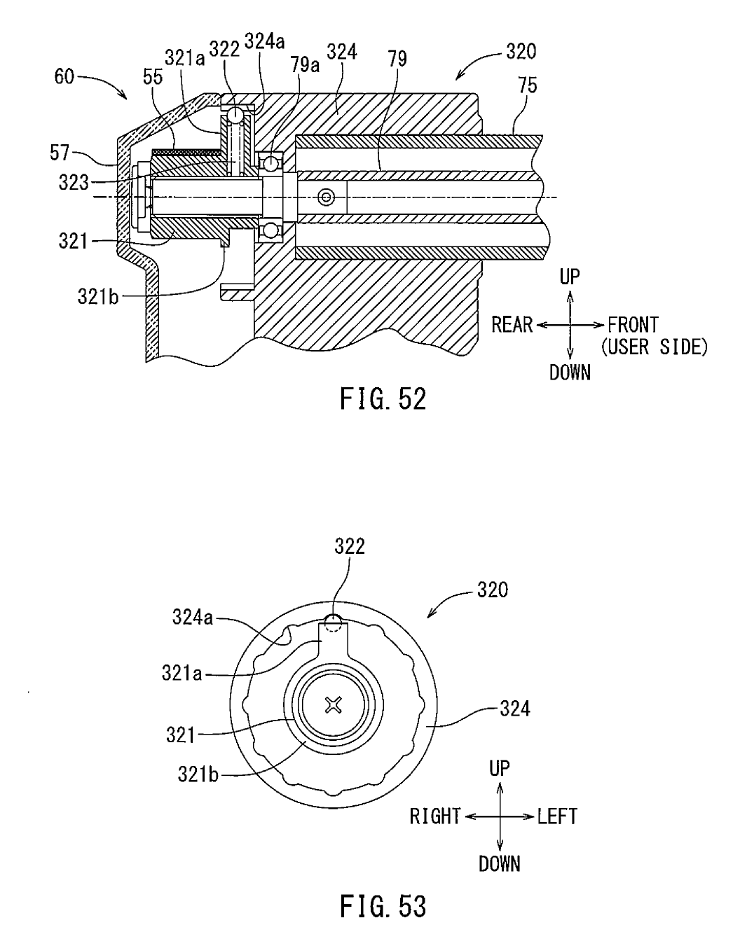

A tabletop cutting device 320 may include a click mechanism shown in FIGS. 52 and 53, instead of the click mechanism shown in FIGS. 50 and 51. The click mechanism in FIGS. 52 and 53 includes a second pulley 321, an engagement pin 322, and a compression spring 323; instead of the second pulley 311, the engagement pin 312, and the compression spring 313 shown in FIGS. 50 and 51. The second pulley 321 includes a flange 321b and a ball supporting portion 321a that protrudes outwardly from the flange 321b in the radial direction. The ball supporting portion 321b includes a hole that extends in the radial direction of the second pulley 321. The engagement ball 322 and the compression spring 323 are housed in the hole. The engagement ball 322 is biased by the compression spring 323 in the outwardly protruding direction, i.e. outward in the radial direction of the second pulley 321.

As shown in FIGS. 52 and 53, a tubular portion formed in a substantially cylindrical shape is provided at the rear end portion of the main body supporting arm 324. A plurality of engagement recesses 324a are arranged within the inner circumference surface of the tubular portion. The plurality of engagement recess 324a are arranged at equally spaced radial intervals along a concentric circle having its radial center coinciding with a rotational center of the second pulley 321. The ball supporting portion 321a is provided in the second pulley 321 such that the engagement ball 322 can engage the engagement recess 324a. The engagement ball 322, which is biased outwardly in the radial direction of the second pulley 321, is elastically pressed so as to enter the engagement recess 324a. Because of this configuration, the second pulley 321 can be positioned at a predetermined angular interval, with the click feeling being produced when the second pulley 321 is rotated in the rotation direction.

As shown in FIGS. 52 and 53, an angle formed between the end portion of the engagement recess 324a and the inner circumference surface of the main body supporting arm 324 may be configured to be smaller than, for example, an angle formed between the end portion of the engagement recess 271b and the outer circumference surface of the flange 271a shown in FIG. 43. Because of this configuration, the user may obtain a less non-smooth feeling when rotating the operation knob 73.

The above-discussed embodiments of the click mechanism arranged around the second pulley may be further modified in various ways. For example, instead of the compression spring, an elastic member made from elastomer can be used as a member that biases the engagement pin or the engagement ball. A position at which an engagement member such as the engagement pin, the engagement ball, the leaf spring, or the resin spring is attached with regard to the arm cover 57 or the main body supporting arm 61 may be changed if needed, on the condition that the engagement member can be engaged with the engagement recess of the second pulley. For example, the position of the engagement ball 242 shown in FIG. 39 may be changed in the circumferential direction if a distance from the rotational center of the second pulley 241 is the same as previously described above.

The number of the engagement pin, the engagement ball, the leaf spring, or the resin spring etc. may be single or plural. Each embodiment of the click mechanism arranged around the second pulley discussed above may be selected and combined if needed.

1. A tabletop cutting device, comprising:
a cutting device main body;
an operation knob that is configured to fix an inclination angle of the cutting device main body when the operation knob is rotated; and
a click mechanism that produces a tactile sensation when the operation knob is rotated.

2. The tabletop cutting device according to claim 1, wherein:
a rotational operation of the operation knob is transmitted to a left/right inclination shaft via a transmission rod positioned away from the left/right inclination shaft,
the left/right inclination shaft is configured to support the cutting device main body so as to incline the cutting device main body in a left-to-right direction, and
the click mechanism is arranged around a radial axis of the transmission rod.

3. The tabletop cutting device according to claim 2, further comprising,
a slide bar that supports the cutting device main body so as to be slidable in a front-to-rear direction, wherein:
the operation knob is rotatably supported at a front end of the slide bar,
the transmission rod is positioned in the slide bar,
the rotational operation of the operation knob is transmitted to the left/right inclination shaft via a belt transmission mechanism that is interposed between the transmission rod and the left/right inclination shaft, and
the click mechanism comprises an engagement portion that is provided in a portion of a pulley on a side of the transmission rod.

4. A tabletop cutting device, comprising:
a cutting device main body slidably supported by a slide bar attached to a main body supporting portion such that the cutting device main body may be inclined in a left-to-right direction with respect to a table on which a workpiece is placed;
a left/right inclination shaft in the main body supporting portion configured to fix a left/right inclination position of the cutting device main body with respect to the table;
an operation knob that is configured to fix an inclination angle of the cutting device main body when the operation knob is rotated, the operation knob being provided at a first end of a transmission rod that is located in the slide bar;
a belt transmission mechanism interposed between a second end of the transmission rod and the left/right inclination shaft, the belt transmission mechanism comprising a pulley and a belt; and
a belt pressing portion that presses the belt towards the pulley.

5. The tabletop cutting device according to claim 4, wherein,
the belt pressing portion is located at a belt outlet portion of the pulley.

6. The tabletop cutting device according to claim 4, wherein,
the belt pressing portion is arranged in a vicinity of the pulley.

7. The tabletop cutting device according to claim 4, wherein,
a plurality belt pressing portions are arranged at a different places.

8. The tabletop cutting device according to claim 4, further comprising a second belt pressing portion that is arranged further away from the pulley than the belt pressing portion and arranged contacting the belt.

9. The tabletop cutting device according to claim 4, wherein the belt transmission mechanism is configured to transmit a rotation operation of the operation knob to the left-right inclination shaft.

10. The tabletop cutting device according to claim 4, further comprising an idler located on an opposite side of the belt to the belt pressing portion.

11. The tabletop cutting device according to claim 6, wherein the belt pressing portion is arrange closer to the pulley than to the left/right inclination shaft.

12. The tabletop cutting device according to claim 1, wherein the tactile sensation is a click feeling.

13. The tabletop cutting device according to claim 1, wherein the click mechanism comprises:
an engagement protrusion; and
a plurality of engagement recesses.

14. The tabletop cutting device according to claim 13, wherein the plurality of engagement recesses are located within a rear surface of a pulley.

15. The tabletop cutting device according to claim 13, wherein the plurality of engagement recesses are located within a front surface of a pulley.

16. The tabletop cutting device according to claim 13, wherein the plurality of engagement recesses are located within an outer peripheral surface of a pulley.

17. The tabletop cutting device according to claim 1, further comprising a left/right inclination shaft about which the cutting device main body rotates.

18. The tabletop cutting device according to claim 17, wherein the operation knob is located nearer to the cutting device main body than to the left/right inclination shaft.

19. The tabletop cutting device according to claim 17, wherein:
the click mechanism is connected to the operation knob via a transmission rod, and
the click mechanism is connected to the left/right inclination shaft via a transmission belt.

20. The tabletop cutting device according to claim 17, wherein the operation knob is located nearer to the click mechanism than to the left/right inclination shaft.
